(19) United States
(12) Patent Application Publication
(10) Pub. No.: US 2025/0013021 A1
(43) Pub. Date: Jan. 9, 2025

(54) PROJECTION LENS

(71) Applicant: YOUNG OPTICS INC., Hsinchu (TW)

(72) Inventor: Hsin-Te Chen, Hsinchu (TW)

(21) Appl. No.: 18/764,278

(22) Filed: Jul. 4, 2024

(30) Foreign Application Priority Data
Jul. 7, 2023 (TW) 112125575

(51) Int. Cl. G02B 13/16; G02B 13/00; G02B 13/18; G02B 15/14

(52) U.S. Cl. CPC G02B 13/16; G02B 13/006; G02B 13/18; G02B 15/142

(57) ABSTRACT

The invention discloses a projection lens. The projection lens includes a first lens with refractive power, a second lens with refractive power, a third lens with refractive power, a fourth lens with refractive power and a fifth lens with refractive power in order from an magnification side to a reduction side of the projection lens. An aperture stop is disposed between the second lens and the reduction side, wherein a number of the lenses refractive power of the projection lens is less than 12, and at least one of the second lens, the third lens, the fourth lens and the fifth lens is a gradient index lens, which satisfies the condition of 0.6>T/D>0.035.

### CROSS-REFERENCE TO RELATED APPLICATION AND CLAIM OF PRIORITY

This application claims the benefit of Taiwan Patent Application No. 112125575, filed on Jul. 7, 2023, at the Taiwan Intellectual Property Office, the disclosures of which are incorporated herein in their entirety by reference.

### FIELD OF THE INVENTION

The present invention is related to projection technology; in particular to projection lenses used in projectors, portable projectors, video walls and etc.

### BACKGROUND OF THE INVENTION

In the past, projectors used to be liquid crystal (LCD) projections, which were relatively large in size. In recent years, as Digital Light Processing (DLP) technology has become mature, the digital micro-mirror devices (DMD, also known as light valve) have been employed, and the size of the projector can thus be significantly reduced. However, the size of the commonly used projection lens can be reduced to a limited extent, due to the optical lens always having various aberrations, which makes the image distorted, such as chromatic aberration.

According to the prior arts, cemented lenses are used for the purpose of achromatization. One disadvantage of which is that two or more lenses are used, resulting in a larger volume and higher cost due to the large number of lenses used. Therefore, how to reduce the size of the projection lens of the light valve projector is an urgent problem to be solved in this technical field.

It is therefore the Applicant's attempt to deal with the above situation encountered in the prior art.

### SUMMARY OF THE INVENTION

To overcome problems in the prior art, the embodiment of the present invention proposes a projection lens, using uneven materials to manufacture lenses to achieve the same achromatic effect without using cemented lenses, or using uneven materials to make cemented lenses. The effect of achromatic aberration is further improved.

In order to achieve the purpose of reducing the lens volume, the projection lens provided by the embodiment of the present invention is made of two or more kinds of materials to manufacture grin lenses, so as to achieve the optical characteristics of the gradient index, and thereby replacing the cemented lens. This gradient index lens is different from the homogeneity of the traditional lens.

The traditional lens is made of homogeneous material, the refraction effect is achieved through the curved surface. The gradient index lens of the embodiment of the present invention makes use of the non-uniform distribution of two or more materials, usually different densities or differently doped materials to make a lens, to achieve the effect of refraction when lights progress therein. The volume of the achromatic lens (element) or lens group (group) can be reduced if the graded index lens is used. Furthermore, the surface shape of the gradient index lens can be a flat lens, a spherical or aspheric structure, a diffractive structure on the surface, or can have a reflex feature. The gradient direction of the graded refractive index can be radial, axial or both radial and axial.

In addition, the sum of refractive power of the lens group between the aperture stop of the projection lens and the image reduction side is positive. As for the lens between the aperture stop of the projection lens and the image magnification side, at least one is an aspherical lens. Furthermore, the f-number of the projection lens is between 1.35 and 2.5. In addition, a gradient index lens may also be used as one of the lenses in the cemented lens. The ΔNd value of the gradient index lens can satisfy the following conditions: ΔNd═Ndₘₐₓ−Ndₘᵢₙ<0.24, where Ndₘₐₓ is the maximum Nd value of the gradient index lens, and Ndₘᵢₙ is the minimum Nd value of the gradient index lens, and the Nd value is the gradient Refractive index of the refractive index of the lens at the helium d-line (helium yellow line, wavelength 587.56 nm). In this way, the size of the projection lens can be further reduced, and the effect of achromatic aberration can be maintained or even improved.

According to one aspect of the present invention, a projection lens is provided. The projection lens includes a plurality of lenses and an aperture stop. The plurality of lenses include at least a first lens with refractive power, a second lens with refractive power, a third lens with refractive power a fourth lens with refractive power, and a fifth lens with refractive power, and are arranged in order from a magnification side to a reduction side. The aperture stop is disposed between the second lens and the reduction side, wherein a sum of the refractive powers of the lenses disposed between the aperture stop and the reduction side is positive, and a number of the lenses with refractive power in the projection lens is less than 12, and at least one of the second lens, the third lens, the fourth lens and the fifth lens is a gradient index lens, which satisfies the condition of 0.6>T/D>0.035, where T is a thickness of the gradient index lens at a center of the gradient index lens, and D is a maximum outer diameter of the gradient index lens.

According to another aspect of the present invention, a projection lens is provided. The projection lens includes a first lens with refractive power, a second lens with refractive power, a third lens with refractive power, a fourth lens with refractive power, and a fifth lens with refractive power, all of which lenses are arranged in order from a magnification side to a reduction side, and an aperture stop disposed between the second lens and the reduction side, wherein a sum of the refractive powers of the lenses disposed between the aperture stop and the reduction side is positive; at least one of the second, the third, the fourth and the fifth lenses is a uneven lens, which satisfies a condition 0.6>T/D>0.035, where T is a thickness at a center of the uneven lens, and D is a maximum outer diameter of the uneven lens, and a total number of lenses having refractive powers in the projection lens is less than 12.

According to another aspect of the present invention, a projection lens is provided. The projection lens includes a first lens with refractive power, a second lens with refractive power, a third lens with refractive power, a fourth lens with refractive power, a fifth lens with refractive power, all of which lenses are arranged in order from a magnification side to a reduction side and an aperture stop. The aperture stop is disposed between the second lens and the reduction side, wherein a sum of the refractive powers of the lenses disposed between the aperture stop and the reduction side is positive; at least one of the second lens, the third lens, the fourth lens and the fifth lens has a flat plate with a smooth surface without any microstructure, and the flat plate satisfies the condition of 0.6>T/D>0.035, where T is a thickness at a center of the flat plate, and D is a maximum outer diameter of the flat plate; and a total number of lenses having refractive power in the projection lens is less than 12.

The size of the projection lens can be further reduced, and the effect of achromatic aberration can be maintained or even improved, which is useful in the field of projection technology. Therefore, the present invention has industrial utility.

### BRIEF DESCRIPTION OF THE DRAWINGS

The objectives and advantages of the present invention will become more readily apparent to those ordinarily skilled in the art after reviewing the following detailed descriptions and accompanying drawings.

FIG. 1 is a schematic diagram showing the lens according to embodiment 1 of the present invention;

FIG. 2 is a schematic diagram showing the lens according to embodiment 2 of the present invention;

FIG. 3 is a schematic diagram showing the lens according to embodiment 3 of the present invention;

FIG. 4 is a schematic diagram showing the lens according to embodiment 4 of the present invention;

FIG. 5 is a schematic diagram showing the lens according to embodiment 5 of the present invention;

FIG. 6 is a schematic diagram showing the lens according to embodiment 6 of the present invention;

FIG. 7 is a schematic diagram showing the lens according to embodiment 7 of the present invention;

FIG. 8 is a schematic diagram showing the lens according to embodiment 8 of the present invention;

FIG. 9 is a schematic diagram showing the lens according to embodiment 9 of the present invention;

FIG. 10 is a schematic diagram showing the lens according to embodiment 10 of the present invention;

FIG. 11 is a schematic diagram showing the lens according to embodiment 11 of the present invention;

FIG. 12 is a schematic diagram showing the lens according to embodiment 12 of the present invention;

FIG. 13 is a schematic diagram showing the lens according to embodiment 13 of the present invention;

FIG. 14 is a schematic diagram showing the lens according to embodiment 14 of the present invention;

FIG. 15 is a schematic diagram showing the lens according to embodiment 15 of the present invention;

FIG. 16 is a schematic diagram showing the lens according to embodiment 16 of the present invention;

FIG. 17 is a schematic diagram showing the lens according to embodiment 17 of the present invention;

FIG. 18 is a schematic diagram showing the lens according to embodiment 18 of the present invention;

FIG. 19 is a schematic diagram showing the lens according to embodiment 19 of the present invention;

FIG. 20 is a schematic diagram showing the lens according to embodiment 20 of the present invention;

FIG. 21 is an MTF diagram of the embodiment 1 of the present invention;

FIG. 22 is an MTF diagram of the embodiment 9 of the present invention;

FIG. 23 is an MTF diagram of the embodiment 10 of the present invention; and

FIG. 24 is an MTF diagram of the embodiment 20 of the present invention.

### DETAILED DESCRIPTION OF THE PREFERRED EMBODIMENTS

The present invention will now be described more specifically with reference to the following embodiments. It is to be noted that the following descriptions of the preferred embodiments of this invention are presented herein for purpose of illustration and description only; they are not intended to be exhaustive or to be limited to the precise form disclosed. The directional terms, such as up, down, left, right, front, back, and etc., mentioned in the following embodiments are only directions referring to the attached drawings. Accordingly, the directional terms used are for the purpose of illustration and not for the purpose of limiting the invention. In addition, the terms “first” and “second” used in the following embodiments are used to identify the same or similar components, and do not intend to limit the components.

The mentioned optical element in the present invention means that the element is made of partially or completely reflective or transmissive materials, usually consisting of glass or plastic. Examples are lenses, prisms, or aperture stops.

When the lens is applied in the imaging system, the image magnification side refers to the side in the optical path close to the subject, and the image reduction side refers to the side closer to the photosensitive element in the optical path.

The object side (or image side) of a lens has a convex surface (or concave surface) located in a certain area, which means that the area is closer to the direction parallel to the center than the outer area adjacent to the area in the radial direction. (“Outwardly convex” or “inwardly concave”)

The summary table of the embodiments used by the present invention is listed as follows, wherein EFL: effective focal length, f/# or fno: aperture, TTL: from the first lens to the last optical lens on the optical axis of the projection lens length, IMH: image height at half field of view, D1: first lens diameter, DL: last lens diameter, FOV: field of view, BFL: last optical lens to light valve Distance, Δnd is ndmax to ndmin, where ndmax is the maximum nd value of progressive refraction lenses, ndmin is the minimum nd value of progressive refraction lenses, that is, Δnd is the maximum nd value of progressive refraction lenses minus ndmin is the minimum nd value of progressive refraction lenses, T/D: Ratio of variable refractive lens thickness (T) to outer diameter (D), f1: EFL from the first lens to stop (aperture stop), f2: EFL from stop (aperture stop) to the last lens, EX1-EX20: Embodiment 1 to Embodiment 20, respectively.

Summary table 1:

| | EFL | Δnd | fno | T/D | IMH | TTL | BFL | FOV |
|---|---|---|---|---|---|---|---|---|
| EX1 | 6.27 | 0.098 | 1.74 | 0.261 | 3.90 | 33.91 | 17.34 | 63.94 |
| EX2 | 6.27 | 0.014 | 1.67 | 0.127 | 3.90 | 33.91 | 17.34 | 63.95 |
| EX3 | 6.24 | 0.183 | 1.69 | 0.138 | 3.90 | 33.91 | 17.34 | 64.06 |
| EX4 | 6.25 | 0.071 | 1.70 | 0.125 | 3.90 | 33.72 | 17.53 | 64.04 |
| EX5 | 6.26 | 0.128 | 1.71 | 0.132 | 3.90 | 33.51 | 17.74 | 64.04 |
| EX6 | 6.25 | 0.042 | 1.70 | 0.207 | 3.90 | 33.83 | 17.42 | 64.02 |
| EX7 | 6.25 | 0.149 | 2.09 | 0.161 | 3.90 | 33.87 | 17.32 | 64.07 |
| EX8 | 5.98 | 0.005 | 1.60 | 0.284 | 5.55 | 69.00 | 20.50 | 85.68 |
| EX9 | 5.29 | 0.062 | 1.79 | 0.083 | 8.33 | 98.52 | 22.71 | 115.28 |
| EX10 | 6.01 | 0.150 | 1.28 | 0.593 | 3.47 | 25.12 | 12.18 | 59.71 |
| EX11 | 9.09 | 0.014 | 2.08 | 0.296 | 3.77 | 23.92 | 13.87 | 44.38 |
| EX12 | 8.92 | 0.010 | 1.63 | 0.070 | 5.55 | 65.98 | 21.52 | 63.89 |
| EX13 | 8.90 | 0.006 | 1.65 | 0.090 | 5.55 | 66.38 | 21.12 | 63.87 |
| EX14 | 8.82 | 0.098 | 1.60 | 0.056 | 5.55 | 66.98 | 20.52 | 63.82 |
| EX15 | 8.82 | 0.126 | 1.58 | 0.044 | 5.55 | 67.02 | 20.48 | 63.80 |
| EX16 | 8.82 | 0.016 | 1.63 | 0.083 | 5.55 | 66.84 | 20.66 | 63.80 |
| EX17 | 8.83 | 0.042 | 1.62 | 0.075 | 5.55 | 63.46 | 21.44 | 63.81 |
| EX18 | 8.82 | 0.054 | 1.51 | 0.083 | 5.55 | 64.48 | 20.94 | 63.80 |
| EX19 | 8.81 | 0.012 | 1.60 | 0.066 | 5.55 | 65.44 | 22.06 | 63.87 |
| EX20 | 6.25 | 0.055 | 1.7 | 0.141 | 3.9 | 33.67 | 17.58 | 64.01 |
| Min. | 5.29 | 0.01 | 1.28 | 0.044 | 3.47 | 23.92 | 12.18 | 44.38 |
| Max. | 9.09 | 0.18 | 2.09 | 0.593 | 8.33 | 98.52 | 22.71 | 115.28 |

Summary Table 2:

| | D1_dia. | DL_dia. | f1 | f2 | BFL/TTL | TTL/IMH | D1/TTL | f1/f2 |
|---|---|---|---|---|---|---|---|---|
| EX1 | 13.60 | 12.41 | 2627.51 | 11.72 | 0.51 | 8.69 | 0.40 | 224.19 |
| EX2 | 13.29 | 12.02 | −70.35 | 11.86 | 0.51 | 8.69 | 0.39 | −5.93 |
| EX3 | 13.11 | 12.60 | 28.82 | 13.26 | 0.51 | 8.69 | 0.39 | 2.17 |
| EX4 | 13.10 | 12.62 | −65.78 | 11.62 | 0.52 | 8.65 | 0.39 | −5.66 |
| EX5 | 12.78 | 12.58 | 149.10 | 12.31 | 0.53 | 8.59 | 0.38 | 12.11 |
| EX6 | 13.20 | 12.51 | −576.92 | 11.45 | 0.51 | 8.67 | 0.39 | −50.39 |
| EX7 | 13.22 | 13.12 | 28.77 | 12.87 | 0.51 | 8.68 | 0.39 | 2.24 |
| EX8 | 29.78 | 19.12 | −87.67 | 17.45 | 0.30 | 12.43 | 0.43 | −5.02 |
| EX9 | 69.35 | 23.35 | 27.25 | 19.98 | 0.23 | 11.83 | 0.70 | 1.36 |
| EX10 | 13.86 | 9.11 | 20.25 | 9.45 | 0.48 | 7.24 | 0.55 | 2.14 |
| EX11 | 11.60 | 10.09 | −39.66 | 7.95 | 0.58 | 6.34 | 0.48 | −4.99 |
| EX12 | 24.65 | 14.65 | 132.30 | 19.14 | 0.33 | 11.89 | 0.37 | 6.91 |
| EX13 | 22.00 | 15.45 | 60.95 | 18.49 | 0.32 | 11.96 | 0.33 | 3.30 |
| EX14 | 30.98 | 16.19 | 90.12 | 17.62 | 0.31 | 12.07 | 0.46 | 5.11 |
| EX15 | 31.74 | 16.58 | 72.07 | 17.62 | 0.31 | 12.08 | 0.47 | 4.09 |
| EX16 | 31.05 | 15.78 | 73.46 | 17.53 | 0.31 | 12.04 | 0.46 | 4.19 |
| EX17 | 29.17 | 17.00 | 44.95 | 19.50 | 0.34 | 11.43 | 0.46 | 2.31 |
| EX18 | 30.07 | 16.32 | 166.80 | 17.97 | 0.32 | 11.62 | 0.47 | 9.28 |
| EX19 | 27.97 | 17.00 | 65.99 | 19.50 | 0.34 | 11.79 | 0.43 | 3.38 |
| EX20 | 13.53 | 12.55 | −105.07 | 11.49 | 0.52 | 8.63 | 0.40 | −9.14 |
| Min. | 11.60 | 9.11 | −576.92 | 7.95 | 0.23 | 6.34 | 0.33 | −50.39 |
| Max. | 69.35 | 23.35 | 2627.51 | 19.98 | 0.58 | 12.43 | 0.70 | 224.19 |

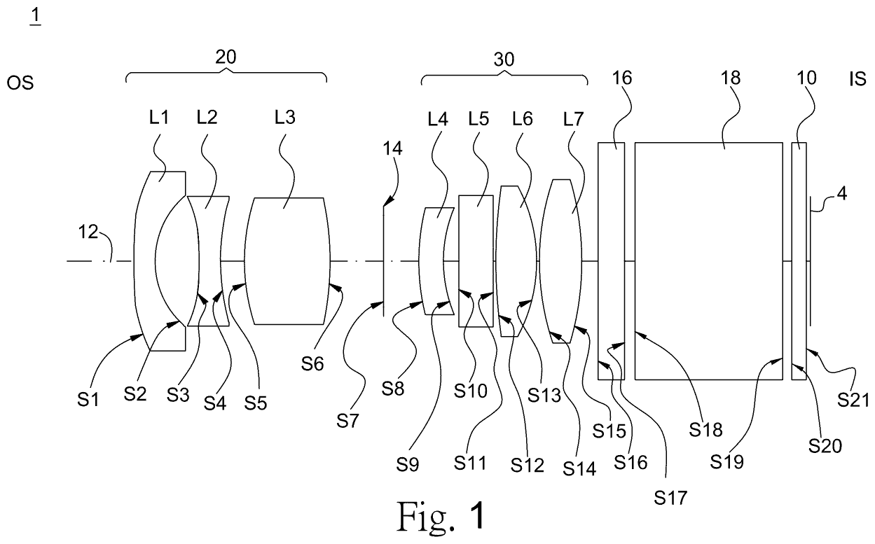

Please refer to FIG. 1, which is a schematic diagram of a lens according to Embodiment 1 (EX1) of the present invention. With a barrel (not shown), the lens 1 has an image magnification side OS and an image reduction side IS. From the image magnification side OS to the image reduction side IS, the lens 1 includes the first lens L1, the second lens L2, the third lens L3, the aperture stop 14, the fourth lens L4, the fifth lens L5, the sixth lens L6 and the seventh lens L7. The side of aperture stop 14 facing the image magnification side OS (object side) is referred to as the front of the aperture stop, also referred to as the forward or front side, and the side of aperture stop 14 facing the image reduction side IS (image side) is referred to as the rear of the aperture stop, also referred to as the backward or rear side.

Behind the seventh lens L7, there are disposed the optical path adjustment mechanism 16, the prism 18, the protective cover 10 and the light valve 4. The first lens L1, the second lens L2 and the third lens L3 form a first lens group (also referred as the front group) 20 with positive refractive power (the f1 value of the general table two EX1), that is, the lens group in front of the aperture stop 14. The fourth lens L4, the fifth lens L5, the sixth lens L6, and the seventh lens L7 constitute the second lens group (also referred as the rear group) 30 with positive refractive power (the f2 value in Table 2 EX1), that is, the rear lens group.

In this embodiment, the refractive powers of the first lens L1 to the seventh lens L7 are respectively negative, negative, positive, negative, negative, positive, and positive, the first and second lenses (L1, L2) are aspherical lenses, and the fifth lens L5 is an uneven lens with a gradient refractive index, which is a flat lens. A gradient refractive index lens is an optical lens in which the refractive index distribution of the internal material changes gradually along the radial or axial direction. An uneven lens, also known as material inhomogeneous lens or inhomogeneous material lens, refers to the lenses containing materials with different refractive indices. The material of the lens closest to the image magnification side OS may be made of glass. The image magnification side OS in each embodiment of the present invention is set on the left side of each figure, that is, the left side of the aperture stop 14, while the image reduction side IS on the right side of each figure, that is, the right side of the aperture stop 14. This will not be repeated hereinafter.

The aperture stop 14 described in the present invention refers to an aperture stop, which is either an independent component or integrated on other optical components. In this embodiment, the aperture stop uses mechanical components to block peripheral light while retaining light transmission in the middle to achieve a similar effect, and the aforementioned mechanical components can be adjustable. The so-called adjustable refers to the adjustment of the position, shape or transparency of the mechanical components. Alternatively, the aperture stop can also be coated with an opaque light-absorbing material on the surface of the lens, so as to keep the central part of the lens transparent to achieve the effect of limiting the light path.

Most of the uneven lenses in this case are radial gradient refractive index, that is, the direction of property change of the uneven material is radial, and the formula for calculating the refractive index is as follows: n(r)=n₀₀+C₁₀r²+C₂₀r⁴+C₃₀r⁶+C₄₀r⁸, where n is the refractive index, r is the radius, n(r) denotes the refractive index of the uneven lens whose radius r is a certain value, n00 is the basic refractive index, and Cᵢ₀ (C₁₀, C₂₀, C₃₀, C₄₀) denote coefficients.

For each of the following embodiments, Table 1 discloses some basic parameters of the lens design corresponding to the drawings, and Table 2 discloses the design parameters of the uneven lens (gradient index lens) corresponding to the drawings. Table 2 shows the value of the basic refractive index and relevant coefficients at each wavelength of light, where the C-line in the horizontal column is the hydrogen C line (hydrogen red line) with the wavelength of 656.27 nm, and the d-line is the helium d line (helium yellow line) with the wavelength of 587.56 nm, and F-line is the hydrogen F line (hydrogen blue line) with the wavelength of 486.13 nm. The reference numeral n₀₀ denotes the base refractive index, and C₁₀, C₂₀, C₃₀, and C₄₀ denote the respective coefficients. In addition, the ΔNd value of the gradient index lens must meet the following conditions: ΔNd=Ndₘₐₓ−Ndₘᵢₙ<0.24, where Ndₘₐₓ is the maximum Nd value of the gradient index lens, and Ndₘᵢₙ is the minimum Nd value of the gradient index lens, the Nd value is the refractive index of the gradient index lens at the helium d-line (wavelength 587.56 nm), and the ΔNd of the fifth lens L5 in FIG. 1 is less than 0.1015. In addition, Table 3 of each embodiment discloses the parameters of the aspheric lens therein.

Table 1 of embodiment 1(EX1):

EFL = 6.27(mm); ΔNd = 0.098; f/# = 1.74;
TTL = 33.91(mm); FOV = 63.94(mm)

| | Radius of | | | | |
|---|---|---|---|---|---|
| | curvature | Pitch | Refractive | Abbe | |
| Surface | (mm) | (mm) | index | number | Element |
| S1 | −95.7 | 1.5 | 1.53 | 56.3 | L1(aspherical) |
| S2 | 6.6 | 3.3 | | | (aspherical) |
| S3 | 1744.6 | 1.6 | 1.53 | 56.3 | L2(aspherical) |
| S4 | 12.5 | 1.8 | | | (aspherical) |
| S5 | 15.4 | 6.5 | 1.76 | 31.5 | L3(double convex) |
| S6 | −22.6 | 4.1 | | | |
| S7 | Infinity | 2.7 | | | Aperture stop 14 |
| S8 | 17.2 | 1.9 | 1.75 | 32.6 | L4(convex & concave) |
| S9 | 10.4 | 1.2 | | | |
| S10* | Infinity | 2.6 | | | L5(uneven) |
| S11* | Infinity | 0.2 | | | |
| S12 | 39.7 | 3.1 | 1.52 | 77.2 | L6(double convex) |
| S13 | −12.0 | 0.2 | | | |
| S14 | 19.2 | 3.2 | 1.64 | 59.4 | L7(double convex) |
| S15 | −22.2 | 1.2 | | | |
| S16 | Infinity | 2.0 | 1.51 | 56.5 | Optical path adjt. |
| | | | | | mechanism 16 |
| S17 | Infinity | 0.8 | | | |
| S18 | Infinity | 11.2 | 1.72 | 38.0 | Prism 18 |
| S19 | Infinity | 0.7 | | | |
| S20 | Infinity | 1.1 | 1.51 | 62.9 | Protective cover 10 |
| S21 | Infinity | 0.3 | | | |

Table 2 of embodiment 1(EX1):

| Uneven Lens (gradient | C-line | d-line | F-line |
|---|---|---|---|
| refractive index) | 656.27 nm | 587.56 nm | 486.13 nm |
| n₀₀ | 1.4892 | 1.4917 | 1.4978 |
| C₁₀ | 3.058E−03 | 3.153E−03 | 3.397E−03 |
| C₂₀ | 3.072E−05 | 3.167E−05 | 3.412E−05 |

Table 3 of embodiment 1(EX1):

| | | | | | | | |
|---|---|---|---|---|---|---|---|
| Surface | K | A\hat{ }4 | B\hat{ }6 | C\hat{ }8 | D\hat{ }10 | E\hat{ }12 | F\hat{ }14 |

| | | | | | |
|---|---|---|---|---|---|
| S1 | 18.049 | 9.3173E−04 | −1.0468E−05 | 7.2743E−08 | 7.5990E−10 |
| S2 | −0.593 | −8.6075E−05 | 4.4846E−05 | −1.5426E−06 | 2.6806E−08 |
| S3 | −99.000 | −3.3934E−03 | 1.5754E−04 | −4.8534E−06 | 6.5320E−08 |
| S4 | −20.509 | −9.1962E−04 | 9.3823E−05 | −3.1780E−06 | 5.0831E−08 |

The pitch of S1 is the distance between the surfaces S1 to S2 at the center 12, the pitch of S2 is the distance between the surfaces S2 to S3 at the center 12, and so on, and the pitch of S20 is the thickness of the protective cover 10. The asterisk mark “*” appearing in the table indicates the surface of an uneven lens (gradient refractive index lens). Without the asterisk mark, the surface belongs to a homogeneous lens. Radius of curvature refers to the reciprocal of curvature. When the radius of curvature is positive, the spherical center of the lens surface is in the direction of the image reduction side of the lens. When the radius of curvature is negative, the spherical center of the lens surface is in the direction of the image magnification side of the lens. The convex and concave of each lens surface can be seen in the table.

The structure and effect of the optical path adjustment mechanism 16 in the embodiment of the present inventions can refer to ROC patent numbered I584045, I613503, I670518, I657307, I629504, I641899, M554179, I767947, I744445, I737875, I691778, I798391 and PRC patent numbered CN 207366814U.

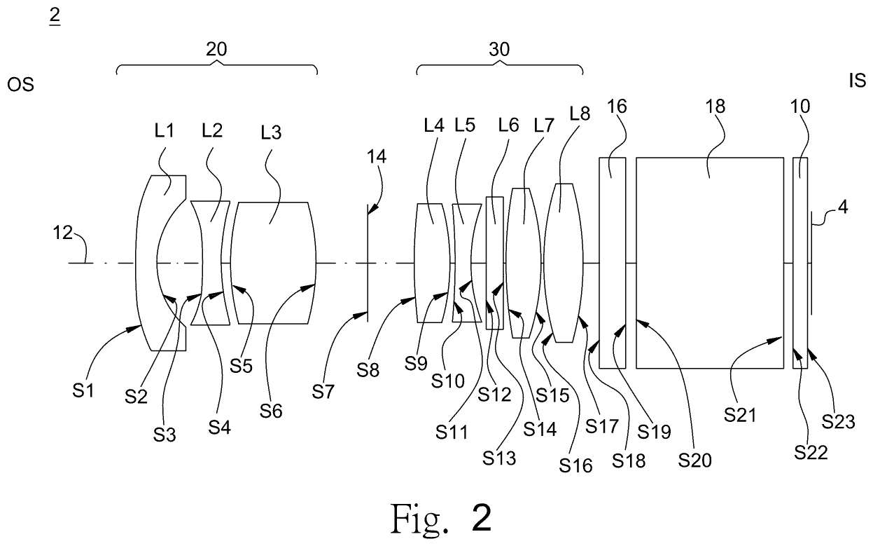

Please refer to FIG. 2, which is a schematic diagram of a lens according to Embodiment 2 (EX2) of the present invention. With a barrel (not shown), the lens 2 has an image magnification side OS and an image reduction side IS. From the image magnification side OS to the image reduction side IS, the lens 2 includes the first lens L1, the second lens L2, the third lens L3, the aperture stop 14, the fourth lens L4, the fifth lens L5, the sixth lens L6, the seventh lens L7 and the eighth lens L8. The side of aperture stop 14 facing the image magnification side OS (object side) is referred to as the front of the aperture stop, also referred to as forward or front side, and the side of aperture stop 14 facing the image reduction side IS (image side) is referred to as the rear of the aperture stop, also referred to as the backward or the rear side.

Behind the eighth lens L8, there are disposed in sequence: the optical path adjustment mechanism 16, the prism 18 and the protective cover 10. The first lens L1, the second lens L2 and the third lens L3 form a first lens group (also referred as the front group) 20 with negative refractive power, that is, the lens group in front of the aperture stop 14. The fourth lens L4, the fifth lens L5, the sixth lens L6, the seventh lens L7 and the eight lens L8 constitute the second lens group (also referred as the rear group) 30 with positive refractive power, that is, the rear lens group.

In this embodiment, the refractive powers of the first lens L1 to the eight lens L8 are respectively negative, negative, positive, positive, negative, positive, positive and positive, the first and second lenses L1, L2 are aspherical lenses, and the sixth lens L6 is an uneven lens with a gradient refractive index, which is a flat lens. The material of the lens closest to the image magnification side OS may be made of glass.

Table 1 of embodiment 2 (EX2):

EFL = 6.27(mm); ΔNd = 0.014; f/# = 1.67;
TTL = 33.91(mm); FOV = 63.95(mm)

| | Radius of | | | | |
|---|---|---|---|---|---|
| | curvature | Pitch | Refractive | Abbe | |
| Surface | (mm) | (mm) | index | number | Element |
| S1 | −317.7 | 1.5 | 1.53 | 56.3 | L1(aspherical) |
| S2 | 6.2 | 3.5 | | | (aspherical) |
| S3 | −200.0 | 1.4 | 1.53 | 56.3 | L2(aspherical) |
| S4 | 11.0 | 0.7 | | | (aspherical) |
| S5 | 17.3 | 6.5 | 1.72 | 28.3 | L3(double convex) |
| S6 | −16.9 | 3.9 | | | |
| S7 | Infinity | 3.5 | | | Aperture stop 14 |
| S8 | 38.4 | 2.7 | 1.60 | 65.4 | L4(double convex) |
| S9 | −16.5 | 0.4 | | | |
| S10 | −48.9 | 1.2 | 1.85 | 23.8 | L5(double concave) |
| S11 | 12.7 | 1.2 | | | |
| S12* | Infinity | 1.3 | | | L6(uneven) |
| S13* | Infinity | 0.2 | | | |
| S14 | 32.3 | 2.7 | 1.63 | 61.1 | L7(double convex) |
| S15 | −18.4 | 0.2 | | | |
| S16 | 20.1 | 3.0 | 1.56 | 59.0 | L8(double convex) |
| S17 | −22.9 | 1.2 | | | |
| S18 | Infinity | 2.0 | 1.51 | 56.5 | Optical path adjt. |
| | | | | | mechanism 16 |
| S19 | Infinity | 0.8 | | | |
| S20 | Infinity | 11.2 | 1.72 | 38.0 | Prism 18 |
| S21 | Infinity | 0.7 | | | |
| S22 | Infinity | 1.1 | 1.51 | 62.9 | Protective lens 10 |
| S23 | Infinity | 0.3 | | | |

Table 2 of embodiment 2(EX2):

| Uneven Lens (gradient | C-line | d-line | F-line |
|---|---|---|---|
| refractive index) | 656.27 nm | 587.56 nm | 486.13 nm |
| n₀₀ | 1.5717 | 1.5768 | 1.5896 |
| C₁₀ | −2.370E−04 | −2.444E−04 | −2.633E−04 |
| C₂₀ | 2.938E−05 | 3.029E−05 | 3.263E−05 |

Table 3 of embodiment 2(EX2):

| | | | | | | | |
|---|---|---|---|---|---|---|---|
| Surface | K | A\hat{ }4 | B\hat{ }6 | C\hat{ }8 | D\hat{ }10 | E\hat{ }12 | F\hat{ }14 |

| | | | | | |
|---|---|---|---|---|---|
| S1 | 99.000 | 8.3079E−04 | −1.1166E−05 | 1.1526E−07 | 7.1609E−10 |
| S2 | −0.395 | −6.4861E−05 | 3.0453E−05 | −1.8398E−06 | 4.2546E−08 |
| S3 | −99.000 | −3.3545E−03 | 1.3271E−04 | −4.1932E−06 | 6.4277E−08 |
| S4 | −13.873 | −1.0776E−03 | 9.0614E−05 | −2.7841E−06 | 4.4305E−08 |

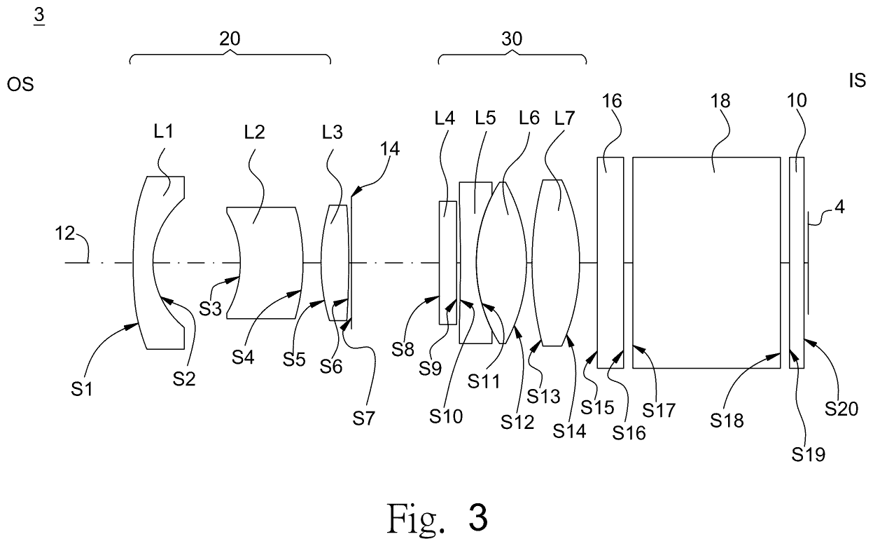

Please refer to FIG. 3, which is a schematic diagram of a lens according to Embodiment 3 (EX3) of the present invention. With a barrel (not shown), the lens 3 has an image magnification side OS and an image reduction side IS. From the image magnification side OS to the image reduction side IS, the lens 2 includes the first lens L1, the second lens L2, the third lens L3, the aperture stop 14, the fourth lens L4, the fifth lens L5, the sixth lens L6 and the seventh lens L7. The side of aperture stop 14 facing the image magnification side OS (object side) is referred to as the front of the aperture stop, also referred to as the forward or front side, and the side of aperture stop 14 facing the image reduction side IS (image side) is referred to as the rear of the aperture stop, also referred to as the backward or rear side.

Behind the seventh lens L7, there are disposed in sequence: the optical path adjustment mechanism 16, the prism 18 and the protective cover 10. The first lens L1, the second lens L2 and the third lens L3 form a first lens group (also referred as the front group) 20 with positive refractive power, that is, the lens group in front of the aperture stop 14. The fourth lens L4, the fifth lens L5, the sixth lens L6 and the seventh lens L7 constitute the second lens group (also referred as the rear group) 30 with positive refractive power, that is, the rear lens group.

In this embodiment, the refractive powers of the first lens L1 to the seventh lens L7 are respectively negative, negative, positive, negative, negative, positive and positive, the first and second lenses L1, L2 are aspherical lenses, and the fourth lens L4 is an uneven lens with a gradient refractive index, which is a flat lens. The material of the lens closest to the image magnification side OS may be made of glass.

Table 1 of embodiment 3(EX3):

EFL = 6.24(mm); ΔNd = 0.183; f/# = 1.69;
TTL = 33.91(mm); FOV = 64.06(mm)

| | Radius of | | | | |
|---|---|---|---|---|---|
| | curvature | Pitch | Refractive | Abbe | |
| Surface | (mm) | (mm) | index | number | Element |
| S1 | 39.3 | 1.5 | 1.53 | 56.3 | L1(aspherical) |
| S2 | 5.9 | 6.6 | | | (aspherical) |
| S3 | −8.1 | 4.8 | 1.53 | 56.3 | L2(aspherical) |
| S4 | −15.7 | 1.4 | | | (aspherical) |
| S5 | 15.1 | 2.1 | 1.78 | 30.6 | L3(double convex) |
| S6 | −62.5 | 0.2 | | | |
| S7 | Infinity | 6.7 | | | Aperture stop14 |
| S8* | Infinity | 1.3 | | | L4(uneven) |
| S9* | Infinity | 0.3 | | | |
| S10 | −139.8 | 1.2 | 1.85 | 23.8 | L5(convex & concave) |
| S11 | 11.5 | 3.8 | 1.50 | 81.5 | L6(double convex) |
| S12 | −12.5 | 0.4 | | | |
| S13 | 24.4 | 3.6 | 1.67 | 56.3 | L7(double convex) |
| S14 | −15.3 | 1.3 | | | |
| S15 | Infinity | 2.0 | 1.51 | 56.5 | Optical path adjt. |
| | | | | | mechanism 16 |
| S16 | Infinity | 0.7 | | | |
| S17 | Infinity | 11.2 | 1.72 | 38.0 | Prism 18 |
| S18 | Infinity | 0.7 | | | |
| S19 | Infinity | 1.1 | 1.51 | 62.9 | Protective lens 10 |
| S20 | Infinity | 0.3 | | | |

Table 2 of embodiment 3(EX3):

| Uneven Lens (gradient | C-line | d-line | F-line |
|---|---|---|---|
| refractive index) | 656.27 nm | 587.56 nm | 486.13 nm |
| n₀₀ | 1.4098 | 1.4117 | 1.4160 |
| C₁₀ | 4.613E−03 | 4.706E−03 | 4.862E−03 |
| C₂₀ | 1.661E−04 | 1.695E−04 | 1.751E−04 |

Table 3 of embodiment 3(EX3):

| | | | | | | | |
|---|---|---|---|---|---|---|---|
| Surface | K | A\hat{ }4 | B\hat{ }6 | C\hat{ }8 | D\hat{ }10 | E\hat{ }12 | F\hat{ }14 |

| | | | | | |
|---|---|---|---|---|---|
| S1 | 0.000 | 3.5598E−04 | −4.3861E−06 | 5.7887E−08 | 7.9321E−11 |
| S2 | 0.000 | −1.3897E−04 | −6.3734E−06 | −2.4591E−07 | 0 |
| S3 | 0.000 | −3.9344E−04 | −1.0927E−06 | 1.2977E−07 | 0 |
| S4 | −10.405 | −4.0495E−04 | 6.9803E−06 | −3.0324E−08 | 0 |

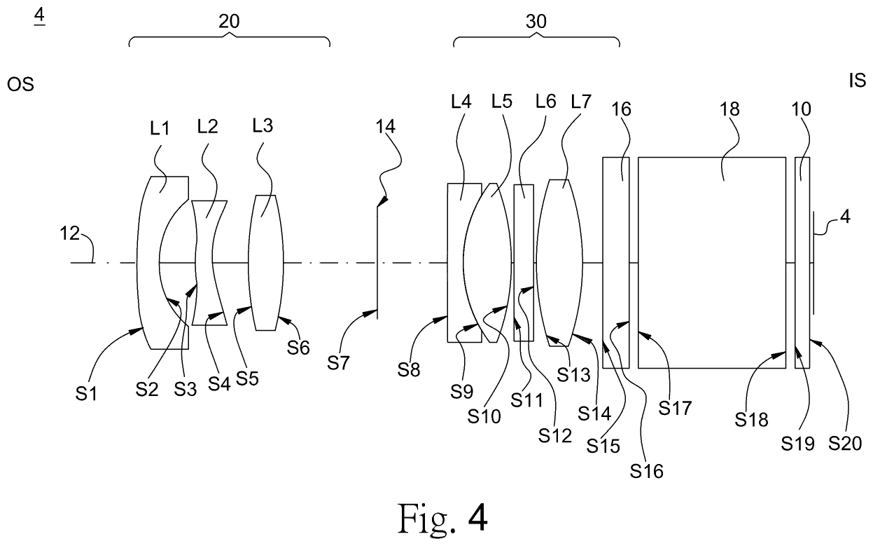

Please refer to FIG. 4, which is a schematic diagram of a lens according to Embodiment 4 (EX4) of the present invention. With a barrel (not shown), the lens 4 has an image magnification side OS and an image reduction side IS. From the image magnification side OS to the image reduction side IS, the lens 2 includes the first lens L1, the second lens L2, the third lens L3, the aperture stop 14, the fourth lens L4, the fifth lens L5, the sixth lens L6 and the seventh lens L7. The side of aperture stop 14 facing the image magnification side OS (object side) is referred to as the front of the aperture, also referred to as forward or front side, and the side of aperture stop 14 facing the image reduction side IS (image side) is referred to as the rear of the aperture stop, also referred to as the backward or rear side.

Behind the seventh lens L7, there are disposed in sequence: the optical path adjustment mechanism 16, the prism 18 and the protective cover 10. The first lens L1, the second lens L2 and the third lens L3 form a first lens group (also referred as the front group) 20 with negative refractive power, that is, the lens group in front of the aperture stop 14. The fourth lens L4, the fifth lens L5, the sixth lens L6 and the seventh lens L7 constitute the second lens group (also referred as the rear group) 30 with positive refractive power, that is, the rear lens group.

In this embodiment, the refractive powers of the first lens L1 to the seventh lens L7 are respectively negative, negative, positive, negative, positive, negative and positive, the first and second lenses L1, L2 are aspherical lenses, and the sixth lens L6 is an uneven lens with a gradient refractive index, which is a flat lens. The material of the lens closest to the image magnification side OS may be made of glass.

Table 1 of embodiment 4(EX4):

EFL = 6.25(mm); ΔNd = 0.071; f/# = 1.70;
TTL = 33.72(mm); FOV = 64.04(mm)

| | Radius of | | | | |
|---|---|---|---|---|---|
| | curvature | Pitch | Refractive | Abbe | |
| Surface | (mm) | (mm) | index | number | Element |
| S1 | −92.9 | 1.6 | 1.53 | 56.3 | L1(aspherical) |
| S2 | 6.7 | 2.7 | | | (aspherical) |
| S3 | 9.5 | 1.3 | 1.53 | 56.3 | L2(aspherical) |
| S4 | 5.1 | 2.7 | | | (aspherical) |
| S5 | 22.4 | 2.7 | 1.83 | 30.5 | L3(double convex) |
| S6 | −21.0 | 7.1 | | | |
| S7 | Infinity | 5.3 | | | Aperture stop 14 |
| S8 | 1060.2 | 1.2 | 1.85 | 23.8 | L4(convex & concave) |
| S9 | 10.1 | 3.7 | 1.63 | 61.8 | |
| S10 | −16.8 | 0.2 | | | L5(double convex) |
| S11* | Infinity | 1.5 | | | L6(uneven) |
| S12* | Infinity | 0.2 | | | |
| S13 | 20.3 | 3.5 | 1.71 | 52.3 | L7(double convex) |
| S14 | −19.0 | 1.5 | | | |
| S15 | Infinity | 2.0 | 1.51 | 56.5 | Optical path adjt. |
| | | | | | mechanism 16 |
| S16 | Infinity | 0.7 | | | |
| S17 | Infinity | 11.2 | 1.72 | 38.0 | Prism 18 |
| S18 | Infinity | 0.7 | | | |
| S19 | Infinity | 1.1 | 1.51 | 62.9 | Protective lens 10 |
| S20 | Infinity | 0.3 | | | |

Table 2 of embodiment 4(EX4):

| Uneven Lens (gradient | C-line | d-line | F-line |
|---|---|---|---|
| refractive index) | 656.27 nm | 587.56 nm | 486.13 nm |
| n₀₀ | 1.5233 | 1.5284 | 1.5400 |
| C₁₀ | 7.654E−04 | 7.730E−04 | 7.678E−04 |
| C₂₀ | 3.523E−05 | 3.558E−05 | 3.534E−05 |

Table 3 of embodiment 4(EX4):

| | | | | | | | |
|---|---|---|---|---|---|---|---|
| Surface | K | A\hat{ }4 | B\hat{ }6 | C\hat{ }8 | D\hat{ }10 | E\hat{ }12 | F\hat{ }14 |

| | | | | | |
|---|---|---|---|---|---|
| S1 | 0 | 9.1152E−04 | −5.7211E−06 | −9.8957E−08 | 2.0581E−09 |
| S2 | 0 | −4.7065E−04 | 6.5683E−05 | −1.3493E−06 | 0 |
| S3 | 0.228 | −6.6977E−03 | 3.1525E−04 | −9.1302E−06 | 1.0408E−07 |
| S4 | −5.244 | −2.2864E−03 | 1.6165E−04 | −5.4303E−06 | 7.5785E−08 |

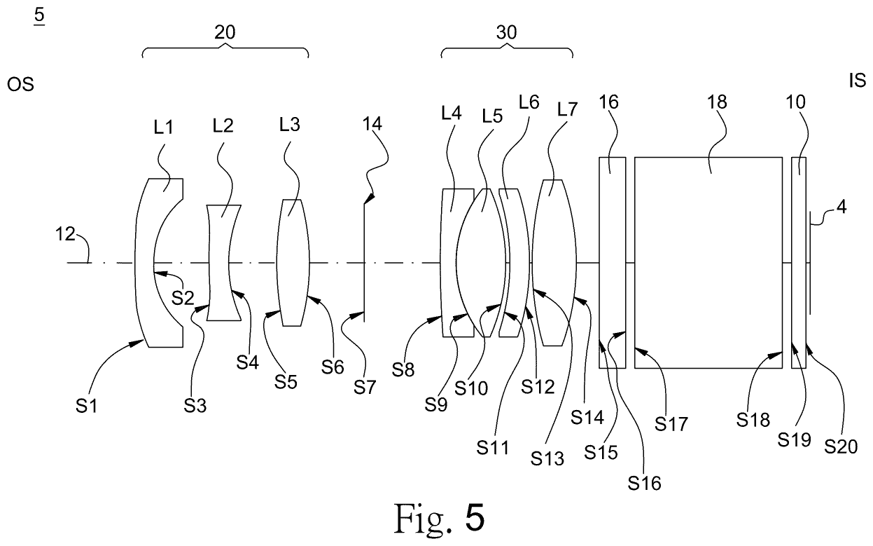

Please refer to FIG. 5, which is a schematic diagram of a lens according to Embodiment 5 (EX5) of the present invention. With a barrel (not shown), the lens 5 has an image magnification side OS and an image reduction side IS. From the image magnification side OS to the image reduction side IS, the lens 5 includes the first lens L1, the second lens L2, the third lens L3, the aperture stop 14, the fourth lens L4, the fifth lens L5, the sixth lens L6 and the seventh lens L7. The side of aperture stop 14 facing the image magnification side OS (object side) is referred to as the front of the aperture, also referred to as forward or front side, and the side of aperture stop 14 facing the image reduction side IS (image side) is referred to as the rear of the aperture stop, also referred to as backward or rear side.

Behind the seventh lens L7, there are disposed in sequence: the optical path adjustment mechanism 16, the prism 18 and the protective cover 10. The first lens L1, the second lens L2 and the third lens L3 form a first lens group (also referred as the front group) 20 with positive refractive power, that is, the lens group in front of the aperture stop 14. The fourth lens L4, the fifth lens L5, the sixth lens L6 and the seventh lens L7 constitute the second lens group (also referred as the rear group) 30 with positive refractive power, that is, the rear lens group.

In this embodiment, the refractive powers of the first lens L1 to the seventh lens L7 are respectively negative, negative, positive, negative, positive, negative and positive, the first and second lenses L1, L2 are aspherical lenses, the sixth lens L6 is an uneven lens with a gradient refractive index, and the sixth lens L6 is a curved lens, which can be spherical, aspherical, or a lens with a diffractive structure. The material of the lens closest to the image magnification side OS may be made of glass.

Table 1 of embodiment 5(EX5):

EFL = 6.25(mm); ΔNd = 0.281; f/# = 1.71;
TTL = 33.51(mm); FOV = 64.04(mm)

| | Radius of | | | | |
|---|---|---|---|---|---|
| | curvature | Pitch | Refractive | Abbe | |
| Surface | (mm) | (mm) | index | number | Element |
| S1 | 215.3 | 1.4 | 1.53 | 56.3 | L1(aspherical) |
| S2 | 7.0 | 4.2 | | | (aspherical) |
| S3 | 10.5 | 1.4 | 1.53 | 56.3 | L2(aspherical) |
| S4 | 4.8 | 3.8 | | | (aspherical) |
| S5 | 24.1 | 2.5 | 1.82 | 31.9 | L3(double convex) |
| S6 | −17.8 | 4.2 | | | |
| S7 | Infinity | 5.8 | | | Aperture stop 14 |
| S8 | 75.9 | 1.2 | 1.85 | 23.8 | L4(convex & concave) |
| S9 | 8.9 | 3.8 | 1.50 | 81.5 | |
| S10 | −13.8 | 0.3 | | | L5(double convex) |
| S11* | −17.1 | 1.5 | | | L6(uneven) |
| S12* | −17.8 | 0.2 | | | |
| S13 | 24.0 | 3.4 | 1.80 | 46.6 | L7(double convex) |
| S14 | −18.5 | 1.7 | | | |
| S15 | Infinity | 2.0 | 1.51 | 56.5 | Optical path adjt. |
| | | | | | mechanism 16 |
| S16 | Infinity | 0.7 | | | |
| S17 | Infinity | 11.2 | 1.72 | 38.0 | Prism 18 |
| S18 | Infinity | 0.7 | | | |
| S19 | Infinity | 1.1 | 1.51 | 62.9 | Protective lens 10 |
| S20 | Infinity | 0.3 | | | |

Table 2 of embodiment 5(EX5):

| Uneven Lens (gradient | C-line | d-line | F-line |
|---|---|---|---|
| refractive index) | 656.27 nm | 587.56 nm | 486.13 nm |
| n₀₀ | 1.5233 | 1.5284 | 1.5400 |
| C₁₀ | 7.654E−04 | 7.730E−04 | 7.678E−04 |
| C₂₀ | 3.523E−05 | 3.558E−05 | 3.534E−05 |

Table 3 of embodiment 5(EX5):

| | | | | | | | |
|---|---|---|---|---|---|---|---|
| Surface | K | A\hat{ }4 | B\hat{ }6 | C\hat{ }8 | D\hat{ }10 | E\hat{ }12 | F\hat{ }14 |

| | | | | | |
|---|---|---|---|---|---|
| S1 | 0 | 7.9732E−04 | −5.5024E−06 | −3.2362E−08 | 8.1821E−10 |
| S2 | 0 | −4.6538E−06 | 3.6819E−05 | −7.0446E−07 | 0 |
| S3 | 1.085 | −6.4268E−03 | 3.0127E−04 | −9.2390E−06 | 1.1759E−07 |
| S4 | −4.484 | −2.4581E−03 | 1.8882E−04 | −6.8356E−06 | 1.0458E−07 |

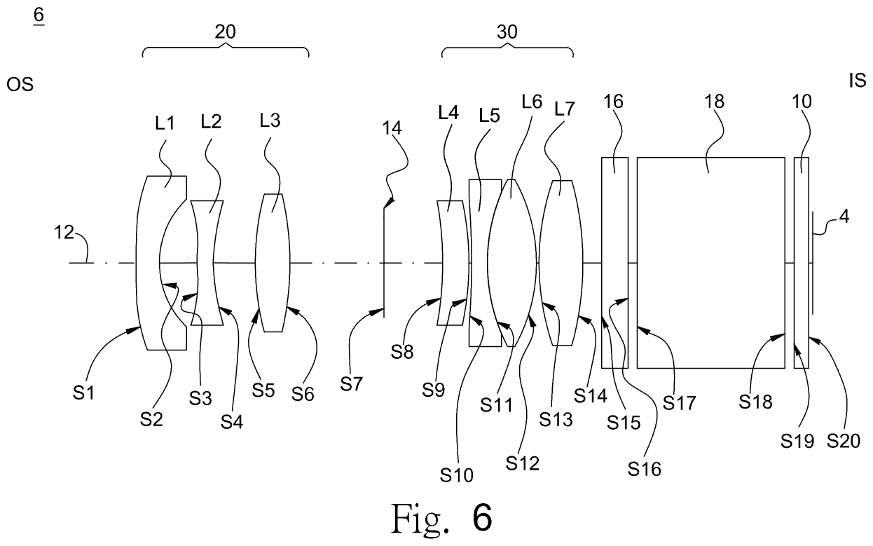

Please refer to FIG. 6, which is a schematic diagram of a lens according to Embodiment 6 (EX6) of the present invention. With a barrel (not shown), the lens 6 has an image magnification side OS and an image reduction side IS. From the image magnification side OS to the image reduction side IS, the lens 5 includes the first lens L1, the second lens L2, the third lens L3, the aperture stop 14, the fourth lens L4, the fifth lens L5, the sixth lens L6 and the seventh lens L7. The side of aperture stop 14 facing the image magnification side OS (object side) is referred to as the front of the aperture stop, also referred to as the forward or front side, and the side of aperture stop 14 facing the image reduction side IS (image side) is referred to as the rear of the aperture stop, also referred to as the backward or rear side.

Behind the seventh lens L7, there are disposed in sequence: the optical path adjustment mechanism 16, the prism 18 and the protective cover 10. The first lens L1, the second lens L2 and the third lens L3 form a first lens group (also referred as the front group) 20 with negative refractive power, that is, the lens group in front of the aperture stop 14. The fourth lens L4, the fifth lens L5, the sixth lens L6 and the seventh lens L7 constitute the second lens group (also referred as the rear group) 30 with positive refractive power, that is, the rear lens group.

In this embodiment, the refractive powers of the first lens L1 to the seventh lens L7 are respectively negative, negative, positive, negative, negative, positive and positive, the first and second lenses L1, L2 are aspherical lenses, the fourth lens L4 is an uneven lens with a gradient refractive index, and the fourth lens L4 is a curved lens, which can be spherical, aspherical, or a lens with a diffractive structure. The material of the lens closest to the image magnification side OS may be made of glass. The curved lens is defined to have a maximum outer diameter, which refers to the distance between the outmost lens surface inflection points of the curved surface in the direction perpendicular to the optical axis.

Table 1 of embodiment 6(EX6):

EFL = 6.25(mm); ΔNd = 0.042; f/# = 1.70;
TTL = 33.83(mm); FOV = 64.02(mm)

| | Radius of | | | | |
|---|---|---|---|---|---|
| | curvature | Pitch | Refractive | Abbe | |
| Surface | (mm) | (mm) | index | number | Element |
| S1 | −65.9 | 1.7 | 1.53 | 56.3 | L1(aspherical) |
| S2 | 6.7 | 2.8 | | | (aspherical) |
| S3 | 10.7 | 1.2 | 1.53 | 56.3 | L2(aspherical) |
| S4 | 5.9 | 3.3 | | | (aspherical) |
| S5 | 20.6 | 2.6 | 1.83 | 37.2 | L3(double convex) |
| S6 | −23.0 | 7.1 | | | |
| S7 | Infinity | 4.5 | | | Aperture stop 14 |
| S8* | −21.5 | 2.0 | | | L4(uneven) |
| S9* | −22.9 | 0.2 | | | |
| S10 | −62.6 | 1.2 | 1.85 | 23.8 | L5(double concave) |
| S11 | 13.9 | 3.7 | 1.62 | 63.3 | L6(double convex) |
| S12 | −13.1 | 0.2 | | | |
| S13 | 19.4 | 3.3 | 1.68 | 55.3 | L7(double convex) |
| S14 | −23.4 | 1.4 | | | |
| S15 | Infinity | 2.0 | 1.51 | 56.5 | Optical path adjt. |
| | | | | | mechanism 16 |
| S16 | Infinity | 0.7 | | | |
| S17 | Infinity | 11.2 | 1.72 | 38.0 | Prism 18 |
| S18 | Infinity | 0.7 | | | |
| S19 | Infinity | 1.1 | 1.51 | 62.9 | Protective lens 10 |
| S20 | Infinity | 0.3 | | | |

Table 2 of embodiment 6(EX6):

| Uneven Lens (gradient | C-line | d-line | F-line |
|---|---|---|---|
| refractive index) | 656.27 nm | 587.56 nm | 486.13 nm |
| n₀₀ | 1.5656 | 1.5710 | 1.5824 |
| C₁₀ | 5.885E−04 | 5.944E−04 | 5.904E−04 |
| C₂₀ | 5.807E−05 | 5.864E−05 | 5.825E−05 |

Table 3 of embodiment 6(EX6):

| | | | | | | | |
|---|---|---|---|---|---|---|---|
| Surface | K | A\hat{ }4 | B\hat{ }6 | C\hat{ }8 | D\hat{ }10 | E\hat{ }12 | F\hat{ }14 |

| | | | | | |
|---|---|---|---|---|---|
| S1 | 0 | 8.5123E−04 | −6.8691E−06 | −4.4272E−08 | 1.4974E−09 |
| S2 | 0 | −5.8616E−04 | 5.7233E−05 | −1.4184E−06 | 0 |
| S3 | 0.176 | −6.7318E−03 | 3.1829E−04 | −9.3873E−06 | 1.1360E−07 |
| S4 | −7.151 | −2.5270E−03 | 1.6840E−04 | −5.3066E−06 | 7.3528E−08 |

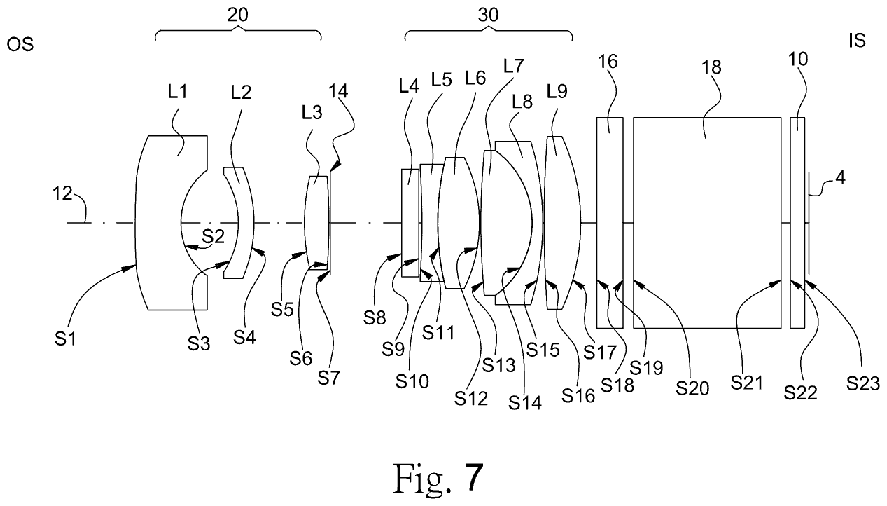

Please refer to FIG. 7, which is a schematic diagram of a lens according to Embodiment 7 (EX7) of the present invention. In this embodiment, the refractive powers of the first lens L1 to the ninth lens L9 are respectively negative, negative, positive, negative, negative, positive, positive, negative and positive, the first lens L1 is an aspherical lens, and the fourth lens LA is an uneven lens with a gradient refractive index, which is a flat lens. The logic for arranging the reference numerals to the elements is the same as those in the aforementioned embodiment, and thus no need to repeat.

Table 1 of embodiment 7(EX7):

EFL = 6.25(mm); ΔNd = 0.149; f/# = 2.09;
TTL = 33.87(mm); FOV = 64.07(mm)

| | Radius of | | | | |
|---|---|---|---|---|---|
| | curvature | Pitch | Refractive | Abbe | |
| Surface | (mm) | (mm) | index | number | Element |
| S1 | 100.0 | 3.5 | 1.58 | 59.2 | L1(aspherical) |
| S2 | 5.6 | 4.4 | | | (aspherical) |
| S3 | −6.7 | 1.2 | 1.60 | 38.0 | L2(convex & concave) |
| S4 | −10.6 | 3.8 | | | |
| S5 | 15.1 | 1.9 | 1.90 | 31.3 | L3(double convex) |
| S6 | −43.5 | 0.1 | | | |
| S7 | Infinity | 5.4 | | | Aperture stop 14 |
| S8* | Infinity | 1.3 | | | L4(uneven) |
| S9* | Infinity | 0.2 | | | |
| S10 | −62.9 | 1.2 | 2.00 | 25.5 | L5(double concave) |
| S11 | 20.8 | 3.2 | 1.50 | 81.5 | L6(double convex) |
| S12 | −11.2 | 0.1 | | | |
| S13 | 55.7 | 3.9 | 1.62 | 63.3 | L7(double convex) |
| S14 | −6.8 | 0.8 | 1.85 | 37.4 | L8(convex & concave) |
| S15 | −21.7 | 0.1 | | | |
| S16 | 89.1 | 2.8 | 1.77 | 49.6 | L9(double convex) |
| S17 | −15.8 | 1.2 | | | |
| S18 | Infinity | 2.0 | 1.51 | 56.5 | Optical path adjt. |
| | | | | | mechanism 16 |
| S19 | Infinity | 0.8 | | | |
| S20 | Infinity | 11.2 | 1.72 | 38.0 | Prism 18 |
| S21 | Infinity | 0.7 | | | |
| S22 | Infinity | 1.1 | 1.51 | 62.9 | Protective lens 10 |
| S23 | Infinity | 0.3 | | | |

Table 2 of embodiment 7(EX7):

| Uneven Lens (gradient | C-line | d-line | F-line |
|---|---|---|---|
| refractive index) | 656.27 nm | 587.56 nm | 486.13 nm |
| n₀₀ | 1.4723 | 1.4754 | 1.4819 |
| C₁₀ | 6.201E−03 | 6.326E−03 | 6.536E−03 |
| C₂₀ | 1.571E−04 | 1.602E−04 | 1.655E−04 |

Table 3 of embodiment 7(EX7):

| Surface | K | A\hat{ }4 | B\hat{ }6 | C\hat{ }8 | D\hat{ }10 | E\hat{ }12 |
|---|---|---|---|---|---|---|
| S1 | −54.61 | 7.4603E−04 | −1.4782E−05 | 2.7736E−07 | −2.7672E−09 | 1.26236E−11 |
| S2 | 0.305 | 7.9149E−04 | −7.9462E−06 | −1.0483E−06 | 5.6610E−08 | 0 |

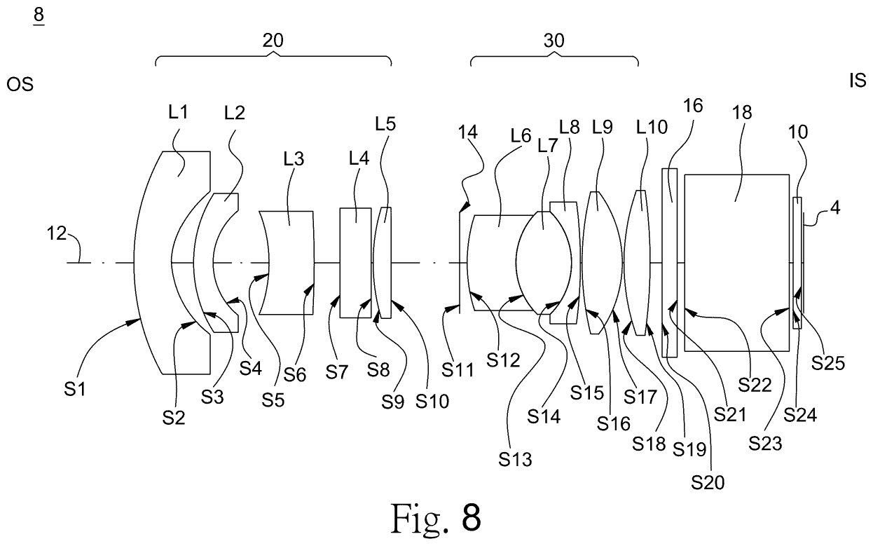

Please refer to FIG. 8, which is a schematic diagram of a lens according to Embodiment 8 (EX8) of the present invention. In this embodiment, the refractive powers of the first lens L1 to the tenth lens L10 are respectively negative, negative, negative, positive, positive, negative, positive, negative, positive and positive, the first and the tenth lenses L1, L10 are aspherical lens, and the fourth lens LA is an uneven lens with a gradient refractive index, which is a flat lens. The logic for arranging the reference numerals to the elements is the same as those in the aforementioned embodiment, and thus no need to repeat.

Table 1 of embodiment 8(EX8):

EFL = 5.98(mm); ΔNd = 0.005; f/# = 1.60;
TTL = 69.00(mm); FOV = 85.68(mm)

| | Radius of | | | | |
|---|---|---|---|---|---|
| | curvature | Pitch | Refractive | Abbe | |
| Surface | (mm) | (mm) | index | number | Element |
| S1 | 32.4 | 5.0 | 1.53 | 56.2 | L1(aspherical) |
| S2 | 9.1 | 3.0 | | | (aspherical) |
| S3 | 17.3 | 2.6 | 1.56 | 72.8 | L2(convex & concave) |
| S4 | 9.0 | 7.5 | | | |
| S5 | −16.3 | 6.0 | 1.55 | 75.6 | L3(convex & concave |
| S6 | −127.2 | 3.4 | | | |
| S7* | Infinity | 4.2 | | | L4(uneven) |
| S8* | Infinity | 0.3 | | | |
| S9 | 25.6 | 2.4 | 1.87 | 26.6 | L5(double convex) |
| S10 | −766.4 | 9.2 | | | |
| S11 | Infinity | 1.0 | | | Aperture stop 14 |
| S12 | 21.2 | 6.5 | 1.78 | 30.6 | L6(convex & concave) |
| S13 | 9.7 | 7.4 | 1.50 | 81.6 | L7(double convex) |
| S14 | −9.7 | 1.2 | 1.87 | 29.1 | L8(convex & concave |
| S15 | −62.1 | 0.2 | | | |
| S16 | 39.6 | 5.4 | 1.50 | 81.6 | L9(double convex) |
| S17 | −16.0 | 0.2 | | | |
| S18 | 26.6 | 3.5 | 1.68 | 31.3 | L10(aspherical) |
| S19 | −54.3 | 1.6 | | | (aspherical) |
| S20 | Infinity | 2.0 | 1.52 | 58.6 | Optical path adjt. |
| | | | | | mechanism 16 |
| S21 | Infinity | 1.0 | | | |
| S22 | Infinity | 14.0 | 1.72 | 38.0 | Prism 18 |
| S23 | Infinity | 0.5 | | | |
| S24 | Infinity | 1.1 | 1.51 | 62.9 | Protective lens 10 |
| S25 | Infinity | 0.3 | | | |

Table 2 of embodiment 8(EX8):

| Uneven Lens (gradient | C-line | d-line | F-line |
|---|---|---|---|
| refractive index) | 656.27 nm | 587.56 nm | 486.13 nm |
| n₀₀ | 1.4723 | 1.4754 | 1.4819 |
| C₁₀ | 1.5138 | 1.5177 | 1.5255 |
| C₂₀ | −2.287E−04 | −2.333E−04 | −2.411E−04 |

Table 3 of embodiment 8(EX8):

| | | | | | | | |
|---|---|---|---|---|---|---|---|
| Surface | K | A\hat{ }4 | B\hat{ }6 | C\hat{ }8 | D\hat{ }10 | E\hat{ }12 | F\hat{ }14 |

| | | | | | |
|---|---|---|---|---|---|
| S1 | 0.453 | −1.0952E−05 | 7.8631E−08 | −1.7105E−10 | 3.1151E−13 |
| S2 | −1.060 | 1.5360E−05 | −1.5141E−08 | 7.8304E−10 | 7.3209E−12 |
| S18 | −2.948 | 6.0681E−07 | 2.2566E−08 | 0 | 0 |
| S19 | −14.168 | 7.4524E−06 | 3.7912E−08 | 0 | 0 |

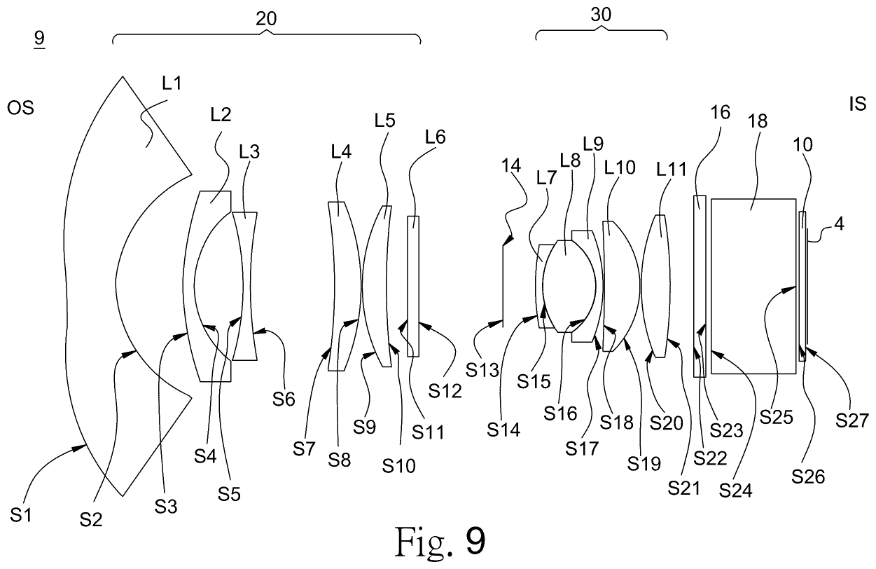

Please refer to FIG. 9, which is a schematic diagram of a lens according to Embodiment 9 (EX9) of the present invention. With a barrel (not shown), the lens 9 has an image magnification side OS and an image reduction side IS. From the image magnification side OS to the image reduction side IS, the lens 9 includes the first lens L1, the second lens L2, the third lens L3, the aperture stop 14, the fourth lens L4, the fifth lens L5, the sixth lens L6, the seventh lens L7, the eighth lens L8, the ninth lens L9, the tenth lens L10 and the eleventh lens 11. The side of aperture stop 14 facing the image magnification side OS (object side) is referred to as the front of the aperture stop, also referred to as the forward or front side, and the side of aperture stop 14 facing the image reduction side IS (image side) is referred to as the rear of the aperture stop, also referred to as the backward or rear side.

Behind the eleventh lens L11, there are disposed in sequence: the optical path adjustment mechanism 16, the prism 18, the protective cover 10 and the light valve 4. The first to the sixth lenses L1-L6 form a first lens group (also referred as the front group) 20 with negative refractive power, that is, the lens group in front of the aperture stop 14. The seventh to the eleventh lenses L7-L11 constitute the second lens group (also referred as the rear group) 30 with positive refractive power, that is, the rear lens group.

In this embodiment, the refractive powers of the first lens L1 to the eleventh lens L11 are respectively negative, negative, negative, positive, positive, positive, negative, positive, negative, positive and positive, the first and second lenses L1, L2 are aspherical lenses, and the sixth lens L6 is an uneven lens with a gradient refractive index, which is a flat lens. The material of the lens closest to the image magnification side OS may be made of glass.

Table 1 of embodiment 9(EX9):

EFL = 5.29(mm); ΔNd = 0.062; f/# = 1.79;
TTL = 98.52(mm); FOV = 115.28(mm)

| | Radius of | | | | |
|---|---|---|---|---|---|
| | curvature | Pitch | Refractive | Abbe | |
| Surface | (mm) | (mm) | index | number | Element |
| S1 | −82.0 | 6.5 | 1.53 | 56.3 | L1(aspherical) |
| S2 | 13.3 | 11.1 | | | (aspherical) |
| S3 | 18.5 | 2.3 | 1.53 | 56.3 | L2(aspherical) |
| S4 | 14.1 | 8.1 | | | (aspherical) |
| S5 | −43.0 | 1.2 | 1.99 | 16.5 | L3(double concave) |
| S6 | 66.0 | 13.9 | | | |
| S7 | −88.4 | 4.4 | 1.84 | 24.0 | L4(concave & convex) |
| S8 | −36.2 | 0.2 | | | |
| S9 | 27.9 | 4.0 | 1.85 | 23.8 | L5(concave & convex) |
| S10 | 100.5 | 3.5 | 1.53 | 56.3 | |
| S11* | Infinity | 1.9 | | | L6(uneven) |
| S12* | Infinity | 13.9 | | | |
| S13 | Infinity | 5.4 | | | Aperture stop 14 |
| S14 | 37.0 | 1.2 | 1.90 | 31.9 | L7(convex & concave) |
| S15 | 12.8 | 8.8 | 1.50 | 81.6 | L8(double convex) |
| S16 | −9.2 | 1.2 | 1.90 | 31.3 | L9(convex & concave) |
| S17 | −24.0 | 0.2 | | | |
| S18 | −198.5 | 5.9 | 1.50 | 81.6 | L10(concave & |
| | | | | | convex) |
| S19 | −15.0 | 0.2 | | | |
| S20 | 30.7 | 4.8 | 1.57 | 70.1 | L11(double convex) |
| S21 | −76.8 | 3.9 | | | |
| S22 | Infinity | 2.0 | 1.52 | 58.6 | Optical path adjt. |
| | | | | | mechanism 16 |
| S23 | Infinity | 0.9 | | | |
| S24 | Infinity | 14.0 | 1.72 | 38.0 | Prism 18 |
| S25 | Infinity | 0.5 | | | |
| S26 | Infinity | 1.1 | 1.52 | 58.6 | Protective lens 10 |
| S27 | Infinity | 0.3 | | | |

Table 2 of embodiment 9(EX9):

| Uneven Lens (gradient | C-line | d-line | F-line |
|---|---|---|---|
| refractive index) | 656.27 nm | 587.56 nm | 486.13 nm |
| n₀₀ | 1.5581 | 1.5629 | 1.5723 |
| C₁₀ | −6.694E−04 | −6.829E−04 | −7.055E−04 |
| C₂₀ | 1.592E−06 | 1.624E−06 | 1.678E−06 |

Table 2 of embodiment 9(EX9):

| Surface | K | A\hat{ }4 | B\hat{ }6 | C\hat{ }8 | D\hat{ }10 | E\hat{ }12 | F\hat{ }14 |
|---|---|---|---|---|---|---|---|
| S1 | −26.345 | 2.3321E−05 | −3.1918E−08 | 2.9927E−11 | −1.6175E−14 | 4.08511E−18 | −26.345 |
| S2 | −0.781 | −8.3574E−05 | 6.8520E−07 | −2.3814E−09 | 4.2356E−12 | −4.01162E−15 | −0.781 |
| S3 | −2.526 | −1.3457E−04 | 9.0283E−07 | −2.7825E−09 | 3.0162E−12 | 0 | −2.526 |
| S4 | −0.656 | −6.9272E−05 | 3.4070E−07 | 2.5720E−09 | −8.7548E−12 | 0 | −0.656 |

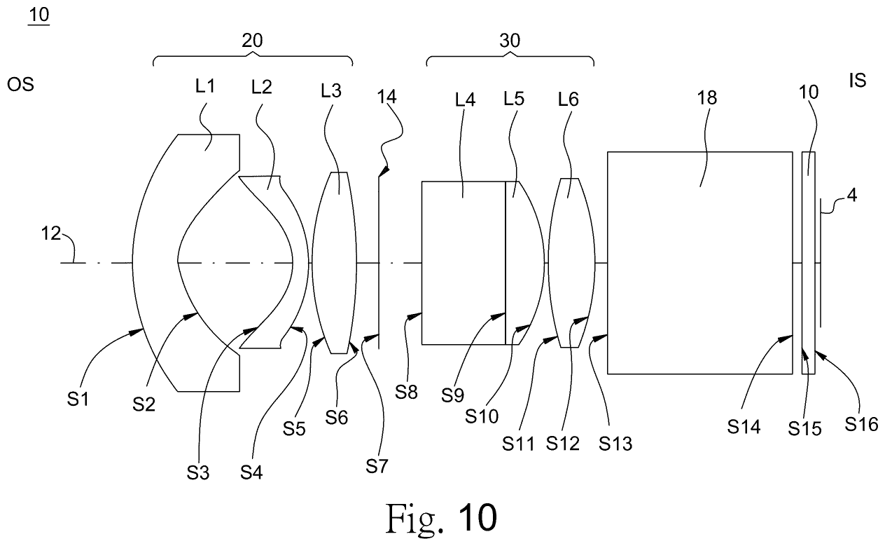

Please refer to FIG. 10, which is a schematic diagram of a lens according to Embodiment 10 (EX10) of the present invention. With a barrel (not shown), the lens 10 has an image magnification side OS and an image reduction side IS. From the image magnification side OS to the image reduction side IS, the lens 10 includes the first lens L1, the second lens L2, the third lens L3, the aperture stop 14, the fourth lens L4, the fifth lens L5 and the sixth lens L6. The side of aperture stop 14 facing the image magnification side OS (object side) is referred to as the front of the aperture stop, also referred to as the forward or front side, and the side of aperture stop 14 facing the image reduction side IS (image side) is referred to as the rear of the aperture stop, also referred to as the backward or rear side. Behind the sixth lens L6, there are disposed in sequence: the prism 18, the protective cover 10 and the light valve 4. The first to the third lenses L1-L3 form a first lens group (also referred as the front group) 20 with negative refractive power, that is, the lens group in front of the aperture stop 14. The fourth to the sixth lenses L4-L6 constitute the second lens group (also referred as the rear group) 30 with positive refractive power, that is, the rear lens group.

In this embodiment, the refractive powers of the first lens L1 to the sixth lens L6 are respectively negative, negative, positive, negative, positive, and positive, the first and second lenses L1, L2 are aspherical lenses, and the fourth lens L4 is an uneven lens with a gradient refractive index, which is a flat lens and also a cemented lens, i.e., cemented with the fifth lens L5. The material of the lens closest to the image magnification side OS may be made of glass.

Table 1 of embodiment 10(EX10):

EFL = 6.01(mm); ΔNd = 0.150; f/# = 1.28;
TTL = 25.12(mm); FOV = 59.71(mm)

| | Radius of | | | | |
|---|---|---|---|---|---|
| | curvature | Pitch | Refractive | Abbe | |
| Surface | (mm) | (mm) | index | number | Element |
| S1 | 7.3 | 2.6 | 1.53 | 56.3 | L1(aspherical) |
| S2 | 3.0 | 6.2 | | | (aspherical) |
| S3 | −3.3 | 0.9 | 1.53 | 56.3 | L2(aspherical) |
| S4 | −4.5 | 0.2 | | | (aspherical) |
| S5 | 12.4 | 2.4 | 1.88 | 40.8 | L3(double convex) |
| S6 | −23.6 | 1.2 | | | |
| S7 | Infinity | 2.3 | | | Aperture stop 14 |
| S8* | Infinity | 4.5 | | | L4(uneven) |
| S9* | Infinity | 2.1 | 1.60 | 65.4 | L5(flat & convex) |
| S10 | −7.7 | 0.2 | | | |
| S11 | 15.6 | 2.5 | 1.50 | 80.0 | L6(double convex) |
| S12 | −12.0 | 0.7 | | | |
| S13 | Infinity | 10.0 | 1.72 | 38.0 | Prism 18 |
| S14 | Infinity | 0.5 | | | |
| S15 | Infinity | 0.7 | 1.51 | 62.9 | Protective lens 10 |
| S16 | Infinity | 0.3 | | | |

Table 2 of embodiment 10(EX10):

| Uneven Lens (gradient | C-line | d-line | F-line |
|---|---|---|---|
| refractive index) | 656.27 nm | 587.56 nm | 486.13 nm |
| n₀₀ | 1.4098 | 1.4116 | 1.4159 |
| C₁₀ | 7.984E−03 | 8.145E−03 | 8.415E−03 |
| C₂₀ | 1.532E−04 | 1.562E−04 | 1.614E−04 |

Table 3 of embodiment 10(EX10):

| Surface | K | A\hat{ }4 | B\hat{ }6 | C\hat{ }8 | D\hat{ }10 |
|---|---|---|---|---|---|
| S1 | −1.902 | −6.6133E−04 | 1.2046E−05 | −7.8123E−08 | 1.5552E−09 |
| S2 | −0.802 | −2.4877E−03 | 1.2371E−05 | −1.8422E−06 | 4.4542E−08 |
| S3 | −0.802 | −3.4955E−04 | −1.2048E−05 | 1.1069E−05 | −2.7457E−07 |
| S4 | −0.716 | 4.2313E−04 | 3.8094E−05 | 4.2255E−06 | −7.8784E−08 |

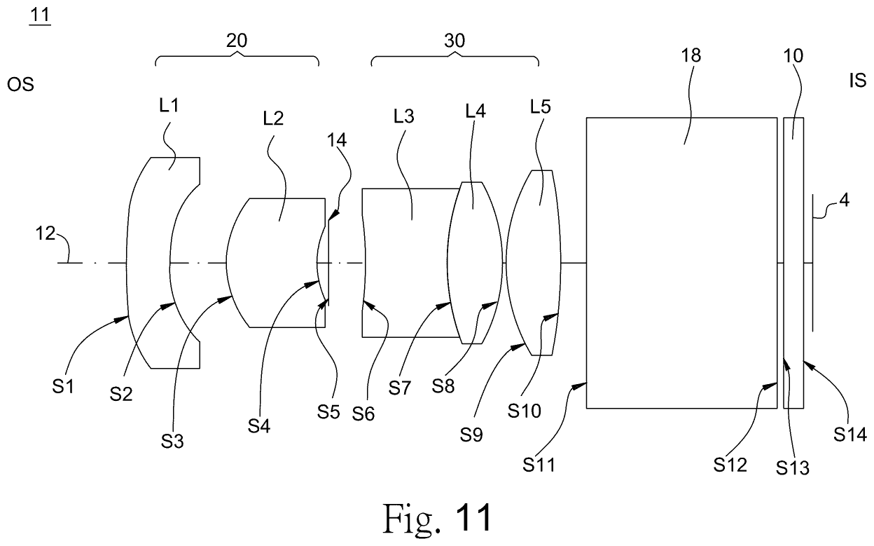

Please refer to FIG. 11, which is a schematic diagram of a lens according to Embodiment 11 (EX11) of the present invention. In this embodiment, the refractive powers of the first lens L1 to the fifth lens L5 are respectively negative, positive, negative, positive and positive, the first and the tenth lenses L1, L10 are aspherical lens, and the fifth lens L5 is an uneven lens with a gradient refractive index, which is a double convex lens. The logic for arranging the reference numerals to the elements is the same as those in the aforementioned embodiment, and thus no need to repeat.

Table 1 of embodiment 11(EX11):

EFL = 9.09(mm); ΔNd = 0.014; f/# = 2.08;
TTL = 23.92(mm); FOV = 44.38(mm)

| | Radius of | | | | |
|---|---|---|---|---|---|
| | curvature | Pitch | Refractive | Abbe | |
| Surface | (mm) | (mm) | index | number | Element |
| S1 | −718.2 | 2.4 | 1.54 | 56.5 | L1(aspherical) |
| S2 | 11.4 | 3.1 | | | (aspherical) |
| S3 | 5.0 | 5.0 | 1.58 | 30.1 | L2(aspherical) |
| S4 | 4.7 | 0.6 | | | (aspherical) |
| S5 | Infinity | 2.0 | | | Aperture stop 14 |
| S6 | −20.2 | 4.5 | 1.85 | 23.8 | L3(double concave) |
| S7 | 12.4 | 3.0 | 1.80 | 46.6 | L4(double convex) |
| S8 | −9.3 | 0.2 | | | |
| S9* | 9.8 | 3.0 | Grin11 | | L5(uneven) |
| S10* | −26.9 | 1.4 | | | |
| S11 | Infinity | 10.5 | 1.66 | 50.9 | Prism 18 |
| S12 | Infinity | 0.4 | | | |
| S13 | Infinity | 1.1 | 1.51 | 62.9 | Protective lens 10 |
| S14 | Infinity | 0.5 | | | |

Table 2 of embodiment 11(EX11):

| Uneven Lens (gradient | C-line | d-line | F-line |
|---|---|---|---|
| refractive index) | 656.27 nm | 587.56 nm | 486.13 nm |
| n₀₀ | 1.4235 | 1.4256 | 1.4304 |
| C₁₀ | −5.910E−04 | −6.029E−04 | −6.229E−04 |
| C₂₀ | 2.419E−06 | 2.468E−06 | 2.550E−06 |

Table 3 of embodiment 11(EX11):

| Surface | K | A\hat{ }4 | B\hat{ }6 | C\hat{ }8 | D\hat{ }10 | E\hat{ }12 |
|---|---|---|---|---|---|---|
| S1 | 0 | 2.0819E−03 | −6.0588E−05 | 1.7145E−06 | −2.6980E−08 | 1.9837E−10 |
| S2 | 0 | 2.5407E−03 | −5.1252E−05 | 1.4710E−06 | 1.4772E−08 | 0 |
| S3 | 0 | −6.2205E−04 | −3.8178E−05 | 1.2390E−06 | −8.9067E−08 | 0 |
| S4 | 0 | −2.8579E−04 | −1.4870E−04 | 3.3222E−05 | −3.4452E−06 | 0 |

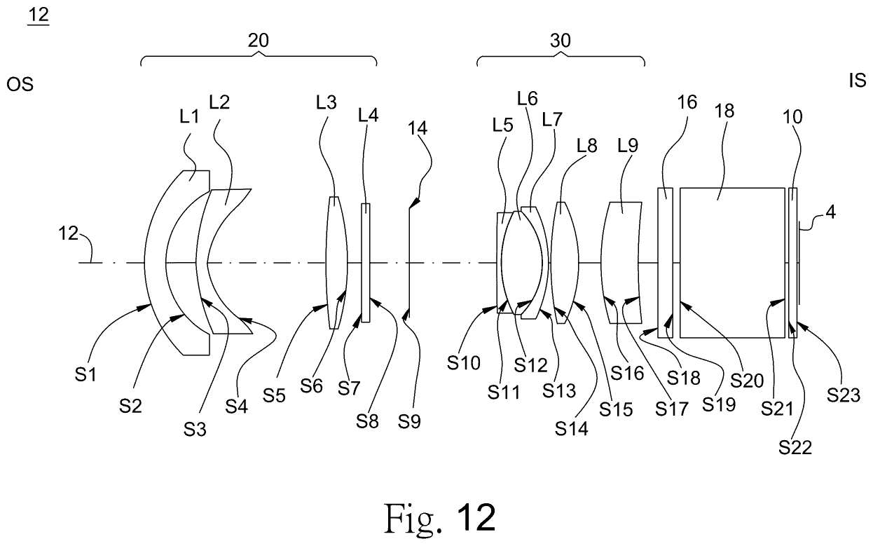

Please refer to FIG. 12, which is a schematic diagram of a lens according to Embodiment 12 (EX12) of the present invention. In this embodiment, the refractive powers of the first lens L1 to the ninth lens L9 are respectively negative, negative, positive, negative, negative, positive, negative, positive and positive, the second lens L2 is an aspherical lens, and the fourth lens LA is an uneven lens with a gradient refractive index, which is a flat lens. The logic for arranging the reference numerals to the elements is the same as those in the aforementioned embodiment, and thus no need to repeat.

Table 1 of embodiment 12(EX12):

EFL = 8.92(mm); ΔNd = 0.010; f/# = 1.63;
TTL = 65.98(mm); FOV = 63.89(mm)

| | Radius of | | | | |
|---|---|---|---|---|---|
| | curvature | Pitch | Refractive | Abbe | |
| Surface | (mm) | (mm) | index | number | Element |
| S1 | 17.3 | 2.8 | 1.82 | 33.9 | L1(convex & concave) |
| S2 | 10.7 | 3.6 | | | |
| S3 | 6.8 | 1.7 | 1.53 | 56.3 | L2(aspherical) |
| S4 | 3.9 | 16.2 | | | (aspherical) |
| S5 | 75.0 | 2.9 | 1.83 | 28.7 | L3(double convex) |
| S6 | −31.7 | 1.9 | | | |
| S7* | Infinity | 1.1 | | | L4(uneven) |
| S8* | Infinity | 5.3 | | | |
| S9 | Infinity | 11.7 | | | Aperture stop 14 |
| S10 | 519.2 | 0.6 | 1.91 | 35.2 | L5(convex & concave) |
| S11 | 15.0 | 5.5 | 1.50 | 81.5 | L6(double convex) |
| S12 | −9.8 | 0.8 | 1.83 | 37.2 | L7(convex & concave |
| S13 | −17.1 | 0.3 | | | |
| S14 | 40.0 | 3.7 | 1.50 | 81.5 | L8(double convex) |
| S15 | −18.3 | 3.0 | | | |
| S16 | 27.6 | 5.0 | 1.77 | 44.6 | L9(concave & convex) |
| S17 | 55.9 | 2.6 | | | |
| S18 | Infinity | 2.0 | 1.51 | 56.5 | Optical path adjt. |
| | | | | | mechanism 16 |
| S19 | Infinity | 1.0 | | | |
| S20 | Infinity | 14.0 | 1.72 | 38.0 | Prism 18 |
| S21 | Infinity | 0.5 | | | |
| S22 | Infinity | 1.1 | 1.51 | 62.9 | Protective lens 10 |
| S23 | Infinity | 0.3 | | | |

Table 2 of embodiment 12(EX12):

| Uneven Lens (gradient | C-line | d-line | F-line |
|---|---|---|---|
| refractive index) | 656.27 nm | 587.56 nm | 486.13 nm |
| n₀₀ | 1.5095 | 1.5134 | 1.5210 |
| C₁₀ | 1.500E−04 | 1.530E−04 | 1.581E−04 |
| C₂₀ | 0 | 0 | 0 |

Table 3 of embodiment 12(EX12):

| Surface | K | A\hat{ }4 | B\hat{ }6 | C\hat{ }8 | D\hat{ }10 | E\hat{ }12 |
|---|---|---|---|---|---|---|
| S3 | −2.10 | −9.3315E−04 | 1.8574E−05 | −2.1725E−07 | 1.3985E−09 | −3.7498E−12 |
| S4 | −0.927 | −1.9837E−03 | 3.7730E−05 | −5.6276E−07 | 4.6818E−09 | −1.6879E−11 |

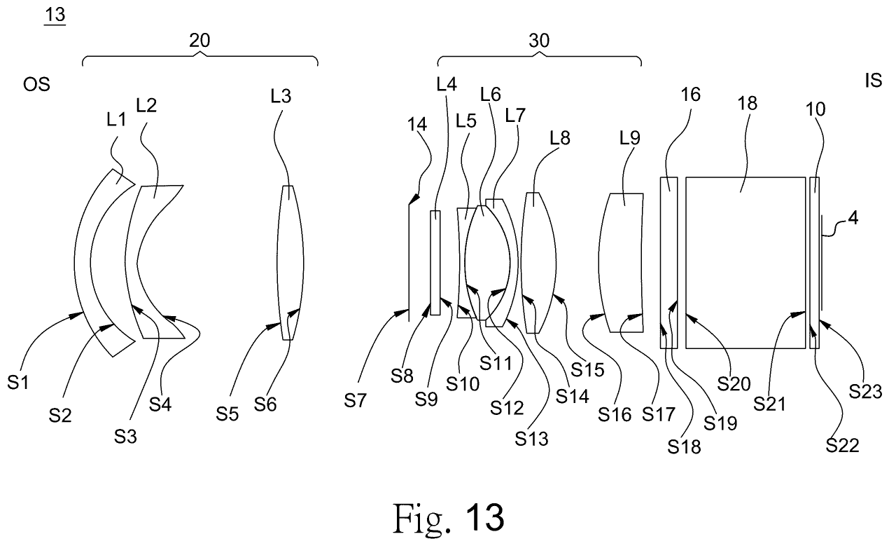

Please refer to FIG. 13, which is a schematic diagram of a lens according to Embodiment 13 (EX13) of the present invention. In this embodiment, the refractive powers of the first lens L1 to the ninth lens L9 are respectively negative, negative, positive, negative, negative, positive, negative, positive and positive, the second lens L2 is an aspherical lens, and the fourth lens LA is an uneven lens with a gradient refractive index, which is a flat lens. The logic for arranging the reference numerals to the elements is the same as those in the aforementioned embodiment, and thus no need to repeat.

Table 1 of embodiment 13(EX13):

EFL = 8.9(mm); ΔNd = 0.006; f/# = 1.65;
TTL = 66.38(mm); FOV = 63.87(mm)

| | Radius of | | | | |
|---|---|---|---|---|---|
| | curvature | Pitch | Refractive | Abbe | |
| Surface | (mm) | (mm) | index | number | Element |
| S1 | 15.7 | 1.9 | 1.81 | 37.1 | L1(convex & concave) |
| S2 | 10.6 | 3.0 | | | |
| S3 | 6.4 | 1.6 | 1.53 | 56.3 | L2(aspherical) |
| S4 | 3.7 | 17.2 | | | (aspherical) |
| S5 | 58.9 | 3.1 | 1.83 | 30.8 | L3(double convex) |
| S6 | −32.2 | 12.3 | | | |
| S7 | Infinity | 2.5 | | | Aperture stop 14 |
| S8* | Infinity | 1.1 | | | L4(uneven) |
| S9* | Infinity | 2.3 | | | |
| S10 | −72.0 | 0.6 | 1.91 | 35.2 | L5(double concave) |
| S11 | 15.7 | 5.3 | 1.50 | 81.5 | L6(double convex) |
| S12 | −9.3 | 1.0 | 1.83 | 37.2 | L7(convex & concave) |
| S13 | −16.0 | 0.3 | | | |
| S14 | 51.1 | 4.1 | 1.50 | 81.5 | L8(double convex) |
| S15 | −17.5 | 5.0 | | | |
| S16 | 24.7 | 5.0 | 1.74 | 50.2 | L9(concave & convex) |
| S17 | 131.3 | 2.2 | | | |
| S18 | Infinity | 2.0 | 1.51 | 56.5 | Optical path adjt. |
| | | | | | mechanism 16 |
| S19 | Infinity | 1.0 | | | |
| S20 | Infinity | 14.0 | 1.72 | 38.0 | Prism 18 |
| S21 | Infinity | 0.5 | | | |
| S22 | Infinity | 1.1 | 1.51 | 62.9 | Protective lens 10 |
| S23 | Infinity | 0.3 | | | |

Table 2 of embodiment 13(EX13):

| Uneven Lens (gradient | C-line | d-line | F-line |
|---|---|---|---|
| refractive index) | 656.27 nm | 587.56 nm | 486.13 nm |
| n₀₀ | 1.5095 | 1.5134 | 1.5210 |
| C₁₀ | 1.500E−04 | 1.530E−04 | 1.581E−04 |
| C₂₀ | 0 | 0 | 0 |

Table 3 of embodiment 13(EX13):

| Surface | K | A\hat{ }4 | B\hat{ }6 | C\hat{ }8 | D\hat{ }10 | E\hat{ }12 |
|---|---|---|---|---|---|---|
| S3 | −2.146 | −9.4355E−04 | 1.8549E−05 | −2.1265E−07 | 1.3423E−09 | −3.5683E−12 |
| S4 | −0.951 | −2.0918E−03 | 4.0853E−05 | −5.9593E−07 | 4.9061E−09 | −1.7668E−11 |

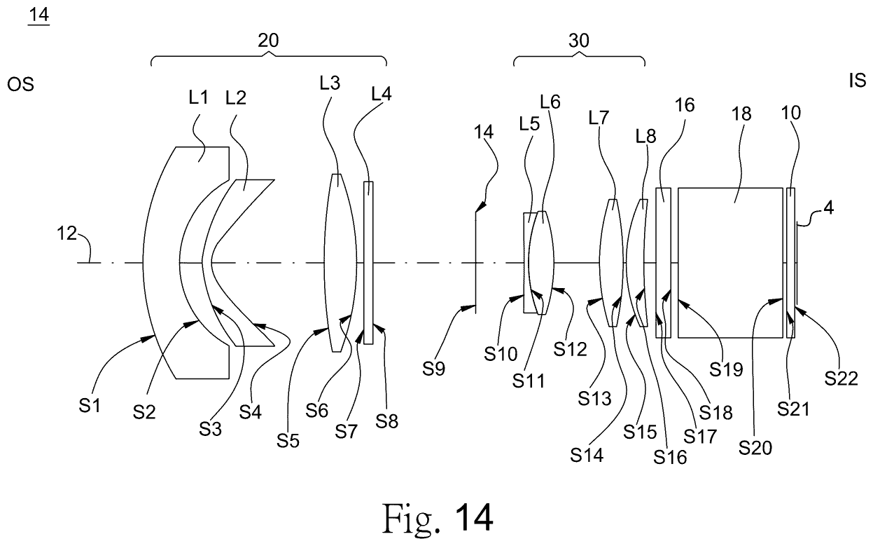

Please refer to FIG. 14, which is a schematic diagram of a lens according to Embodiment 14 (EX14) of the present invention. In this embodiment, the refractive powers of the first lens L1 to the eighth lens L8 are respectively negative, negative, positive, positive, negative, positive, positive and positive, the second lens L2 is an aspherical lens, and the fourth lens LA is an uneven lens with a gradient refractive index, which is a flat lens. The logic for arranging the reference numerals to the elements is the same as those in the aforementioned embodiment, and thus no need to repeat.

Table 1 of embodiment 14(EX14):

EFL = 8.82(mm); ΔNd = 0.098; f/# = 1.60;
TTL = 66.98(mm); FOV = 63.82(mm)

| | Radius of | | | | |
|---|---|---|---|---|---|
| | curvature | Pitch | Refractive | Abbe | |
| Surface | (mm) | (mm) | index | number | Element |
| S1 | 29.4 | 4.9 | 1.80 | 46.8 | L1(convex & concave) |
| S2 | 12.6 | 2.4 | | | |
| S3 | 5.8 | 1.4 | 1.53 | 56.3 | L2(aspherical) |
| S4 | 3.9 | 15.6 | | | (aspherical) |
| S5 | 66.0 | 4.4 | 1.82 | 34.4 | L3(double convex) |
| S6 | −33.8 | 1.0 | | | |
| S7* | Infinity | 1.2 | | | L4(uneven) |
| S8* | Infinity | 13.7 | | | |
| S9 | Infinity | 6.5 | | | Aperture stop 14 |
| S10 | −556.1 | 0.6 | 1.84 | 24.6 | L5(double concave) |
| S11 | 19.3 | 3.4 | 1.50 | 81.5 | L6(double convex) |
| S12 | −22.0 | 6.1 | | | |
| S13 | 28.8 | 3.1 | 1.50 | 81.5 | L7(double convex ) |
| S14 | −41.8 | 0.4 | | | |
| S15 | 20.3 | 2.4 | 1.70 | 53.5 | L8(concave & convex) |
| S16 | 63.7 | 1.6 | | | |
| S17 | Infinity | 2.0 | 1.51 | 56.5 | Optical path adjt. |
| | | | | | mechanism 16 |
| S18 | Infinity | 1.0 | | | |
| S19 | Infinity | 14.0 | 1.72 | 38.0 | Prism 18 |
| S20 | Infinity | 0.5 | | | |
| S21 | Infinity | 1.1 | 1.51 | 62.9 | Protective lens 10 |
| S22 | Infinity | 6.5 | | | |

Table 2 of embodiment 14(EX14):

TABLE 2

| Uneven Lens (gradient | C-line | d-line | F-line |
|---|---|---|---|
| refractive index) | 656.27 nm | 587.56 nm | 486.13 nm |
| n₀₀ | 1.5535 | 1.5583 | 1.5675 |
| C₁₀ | −7.235E−04 | −7.381E−04 | −7.626E−04 |
| C₂₀ | −7.794E−07 | −7.951E−07 | −8.215E−07 |

Table 3 of embodiment 14(EX14):

| Surface | K | A\hat{ }4 | B\hat{ }6 | C\hat{ }8 | D\hat{ }10 | E\hat{ }12 |
|---|---|---|---|---|---|---|
| S3 | −1.790 | −6.5959E−04 | 1.1114E−05 | −1.0274E−07 | 5.0391E−10 | −9.8034E−13 |
| S4 | −0.907 | −1.6988E−03 | 2.3404E−05 | −2.7101E−07 | 1.6581E−09 | −4.5045E−12 |

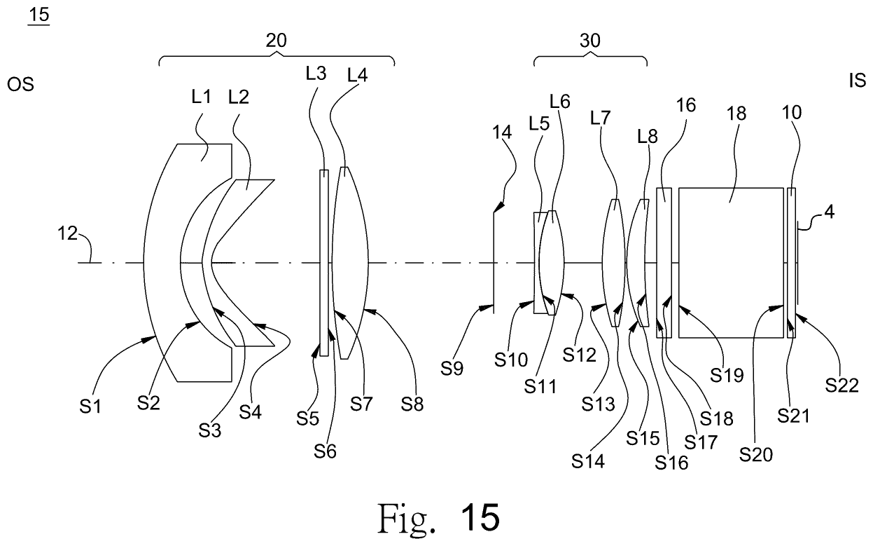

Please refer to FIG. 15, which is a schematic diagram of a lens according to Embodiment 15 (EX15) of the present invention. In this embodiment, the refractive powers of the first lens L1 to the eighth lens L8 are respectively negative, negative, positive, positive, negative, positive, positive and positive, the second lens L2 is an aspherical lens, and the third lens L3 is an uneven lens with a gradient refractive index, which is a flat lens. The logic for arranging the reference numerals to the elements is the same as those in the aforementioned embodiment, and thus no need to repeat.

Table 1 of embodiment 15(EX15):

EFL = 8.82(mm); ΔNd = 0.126; f/# = 1.58;
TTL = 67.02(mm); FOV = 63.80(mm)

| | Radius of | | | | |
|---|---|---|---|---|---|
| | curvature | Pitch | Refractive | Abbe | |
| Surface | (mm) | (mm) | index | number | Element |
| S1 | 30.2 | 4.9 | 1.80 | 47.0 | L1(convex & concave) |
| S2 | 12.8 | 2.5 | | | |
| S3 | 5.8 | 1.4 | 1.53 | 56.3 | L2(aspherical) |
| S4 | 3.9 | 14.8 | | | (aspherical) |
| S5* | Infinity | 1.1 | | | L3(uneven) |
| S6* | Infinity | 0.5 | | | |
| S7 | 71.7 | 4.8 | 1.8 | 37.3 | L4(double convex) |
| S8 | −31.4 | 16.8 | | | |
| S9 | Infinity | 5.5 | | | Aperture stop 14 |
| S10 | −251.5 | 0.6 | 1.8 | 25.0 | L5(double concave) |
| S11 | 19.6 | 3.3 | 1.5 | 81.5 | L6(double convex) |
| S12 | −21.9 | 5.1 | | | |
| S13 | 28.8 | 3.1 | 1.5 | 81.5 | L7(double convex) |
| S14 | −41.4 | 0.2 | | | |
| S15 | 20.5 | 2.4 | 1.7 | 51.5 | L8(concave & convex) |
| S16 | 61.4 | 1.6 | | | |
| S17 | Infinity | 2.0 | 1.5 | 56.5 | Optical path adjt. |
| | | | | | mechanism 16 |
| S18 | Infinity | 1.0 | | | |
| S19 | Infinity | 14.0 | 1.7 | 38.0 | Prism 18 |
| S20 | Infinity | 0.5 | | | |
| S21 | Infinity | 1.1 | 1.5 | 62.9 | Protective lens 10 |
| S22 | Infinity | 0.3 | | | |

Table 2 of embodiment 15(EX15):

| Uneven Lens (gradient | C-line | d-line | F-line |
|---|---|---|---|
| refractive index) | 656.27 nm | 587.56 nm | 486.13 nm |
| n₀₀ | 1.5499 | 1.5546 | 1.5636 |
| C₁₀ | −7.732E−04 | −7.888E−04 | −8.150E−04 |
| C₂₀ | −1.480E−07 | −1.509E−07 | −1.559E−07 |

Table 3 of embodiment 15(EX15):

| Surface | K | A\hat{ }4 | B\hat{ }6 | C\hat{ }8 | D\hat{ }10 | E\hat{ }12 |
|---|---|---|---|---|---|---|
| S3 | −1.788 | −6.1644E−04 | 9.9135E−06 | −8.9317E−08 | 4.2613E−10 | −8.0638E−13 |
| S4 | −0.906 | −1.6415E−03 | 2.1613E−05 | −2.4698E−07 | 1.4899E−09 | −4.0313E−12 |

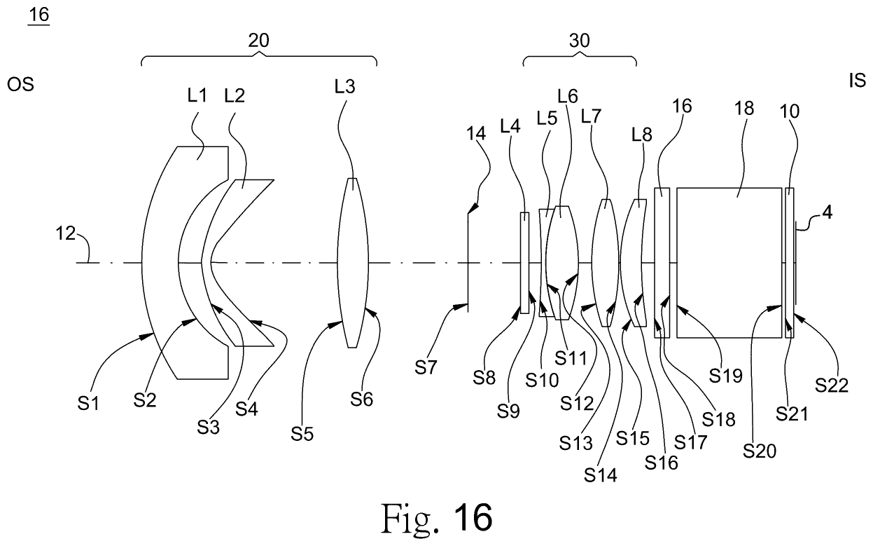

Please refer to FIG. 16, which is a schematic diagram of a lens according to Embodiment 16 (EX16) of the present invention. In this embodiment, the refractive powers of the first lens L1 to the eighth lens L8 are respectively negative, negative, positive, positive, negative, positive, positive and positive, the second lens L2 is an aspherical lens, and the fourth lens L4 is an uneven lens with a gradient refractive index, which is a flat lens. The logic for arranging the reference numerals to the elements is the same as those in the aforementioned embodiment, and thus no need to repeat.

Table 1 of embodiment 16(EX16):

EFL = 8.82(mm); ΔNd = 0.016; f/# = 1.63;
TTL = 66.84(mm); FOV = 63.80(mm)

| | Radius of | | | | |
|---|---|---|---|---|---|
| | curvature | Pitch | Refractive | Abbe | |
| Surface | (mm) | (mm) | index | number | Element |
| S1 | 27.7 | 4.9 | 1.76 | 49.1 | L1(convex & concave) |
| S2 | 12.7 | 2.6 | | | |
| S3 | 6.0 | 1.6 | 1.53 | 56.3 | L2(aspherical) |
| S4 | 3.9 | 17.1 | | | (aspherical) |
| S5 | 45.1 | 4.2 | 1.81 | 37.9 | L3(double convex) |
| S6 | −40.7 | 13.3 | | | |
| S7 | Infinity | 7.0 | | | Aperture stop 14 |
| S8* | Infinity | 1.1 | | | L4(uneven) |
| S9* | Infinity | 1.6 | | | |
| S10 | −88.3 | 0.6 | 1.84 | 25.6 | L5(double concave) |
| S11 | 22.4 | 4.4 | 1.50 | 81.5 | L6(double convex) |
| S12 | −22.0 | 1.8 | | | |
| S13 | 26.7 | 3.6 | 1.50 | 81.5 | L7(double convex) |
| S14 | −31.9 | 0.2 | | | |
| S15 | 20.3 | 2.8 | 1.69 | 54.8 | L8(concave & convex) |
| S16 | 47.3 | 1.8 | | | |
| S17 | Infinity | 2.0 | 1.51 | 56.5 | Optical path adjt. |
| | | | | | mechanism 16 |
| S18 | Infinity | 1.0 | | | |
| S19 | Infinity | 14.0 | 1.72 | 38.0 | Prism 18 |
| S20 | Infinity | 0.5 | | | |
| S21 | Infinity | 1.1 | 1.51 | 62.9 | Protective lens 10 |
| S22 | Infinity | 0.3 | | | |

Table 2 of embodiment 16(EX16):

| Uneven Lens (gradient | C-line | d-line | F-line |
|---|---|---|---|
| refractive index) | 656.27 nm | 587.56 nm | 486.13 nm |
| n₀₀ | 1.5553 | 1.5601 | 1.5693 |
| C₁₀ | −1.340E−04 | −1.367E−04 | −1.412E−04 |
| C₂₀ | 1.024E−05 | 1.045E−05 | 1.080E−05 |

Table 3 of embodiment 16(EX16):

| Surface | K | A\hat{ }4 | B\hat{ }6 | C\hat{ }8 | D\hat{ }10 | E\hat{ }12 |
|---|---|---|---|---|---|---|
| S3 | −1.643 | −6.8818E−04 | 1.0679E−05 | −9.4261E−08 | 4.5831E−10 | −9.1048E−13 |
| S4 | −0.906 | −1.6051E−03 | 2.1028E−05 | −2.3843E−07 | 1.4701E−09 | −4.1304E−12 |

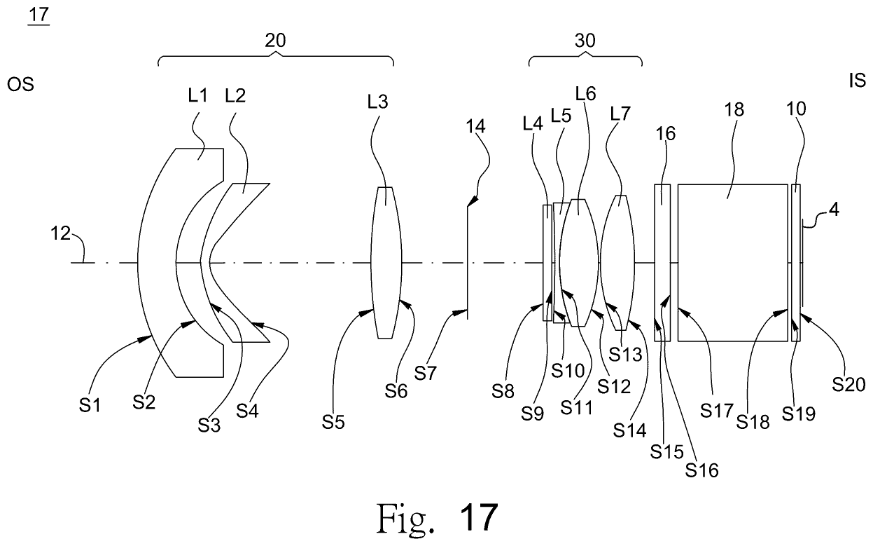

Please refer to FIG. 17, which is a schematic diagram of a lens according to Embodiment 17 (EX17) of the present invention. In this embodiment, the refractive powers of the first lens L1 to the seventh lens L7 are respectively negative, negative, positive, positive, negative, positive and positive, the second lens L2 is an aspherical lens, and the fourth lens L4 is an uneven lens with a gradient refractive index, which is a flat lens. The logic for arranging the reference numerals to the elements is the same as those in the aforementioned embodiment, and thus no need to repeat.

Table 1 of embodiment 17(EX17):

EFL = 8.83(mm); ΔNd = 0.042; f/# = 1.62;
TTL = 63.46(mm); FOV = 63.81(mm)

| | Radius of | | | | |
|---|---|---|---|---|---|
| | curvature | Pitch | Refractive | Abbe | |
| Surface | (mm) | (mm) | index | number | Element |
| S1 | 24.2 | 4.9 | 1.70 | 53.0 | L1(convex & concave) |
| S2 | 12.1 | 2.5 | | | |
| S3 | 5.8 | 1.5 | 1.53 | 56.3 | L2(aspherical) |
| S4 | 3.7 | 20.9 | | | aspherical) |
| S5 | 50.9 | 3.9 | 1.81 | 40.5 | L3(double convex) |
| S6 | −37.1 | 8.4 | | | |
| S7 | Infinity | 9.7 | | | Aperture stop 14 |
| S8* | Infinity | 1.1 | | | L4(uneven) |
| S9* | Infinity | 0.4 | | | |
| S10 | −152.2 | 0.6 | 1.85 | 23.8 | L5(double concave) |
| S11 | 22.0 | 5.0 | 1.50 | 81.5 | L6(double convex) |
| S12 | −19.3 | 0.2 | | | |
| S13 | 19.6 | 4.4 | 1.50 | 81.5 | L7(double convex) |
| S14 | −33.3 | 2.5 | | | |
| S15 | Infinity | 2.0 | 1.51 | 56.5 | Optical path adjt. |
| | | | | | mechanism 16 |
| S16 | Infinity | 1.0 | | | |
| S17 | Infinity | 14.0 | 1.72 | 38.0 | Prism 18 |
| S18 | Infinity | 0.5 | | | |
| S19 | Infinity | 1.1 | 1.51 | 62.9 | Protective lens 10 |
| S20 | Infinity | 0.3 | | | |

Table 2 of embodiment 17(EX17):

| Uneven Lens (gradient | C-line | d-line | F-line |
|---|---|---|---|
| refractive index) | 656.27 nm | 587.56 nm | 486.13 nm |
| n₀₀ | 1.4635 | 1.4665 | 1.4726 |
| C₁₀ | −2.204E−03 | −2.249E−03 | −2.323E−03 |
| C₂₀ | 2.918E−05 | 2.977E−05 | 3.076E−05 |

Table 3 of embodiment 17(EX17):

| Surface | K | A\hat{ }4 | B\hat{ }6 | C\hat{ }8 | D\hat{ }10 | E\hat{ }12 |
|---|---|---|---|---|---|---|
| S3 | −1.624 | −6.3219E−04 | 9.7030E−06 | −8.8244E−08 | 4.4447E−10 | −9.2379E−13 |
| S4 | −0.943 | −1.4540E−03 | 1.9662E−05 | −2.2170E−07 | 1.3969E−09 | −3.8672E−12 |

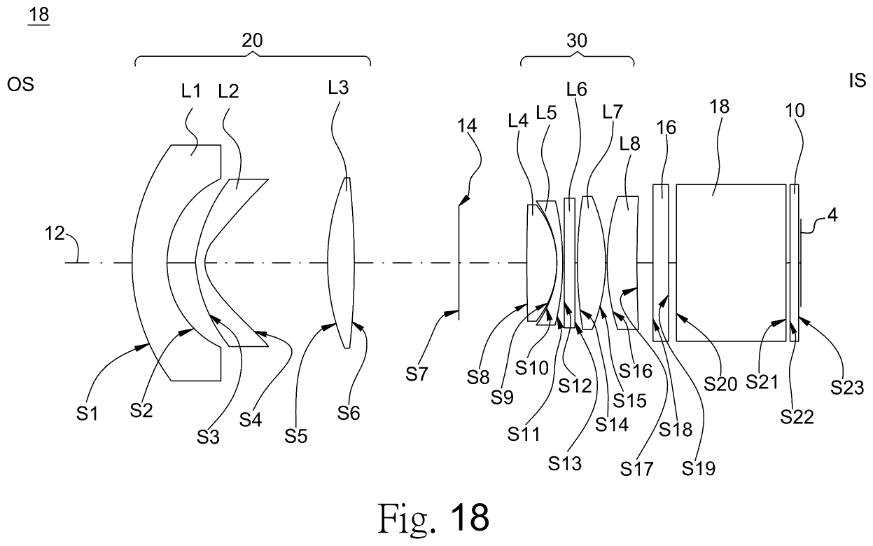

Please refer to FIG. 18, which is a schematic diagram of a lens according to Embodiment 18 (EX18) of the present invention. In this embodiment, the refractive powers of the first lens L1 to the eighth lens L8 are respectively negative, negative, positive, positive, negative, positive, positive and positive, the second lens L2 is an aspherical lens, and the sixth lens L6 is an uneven lens with a gradient refractive index, which is a flat lens. The logic for arranging the reference numerals to the elements is the same as those in the aforementioned embodiment, and thus no need to repeat.

Table 1 of embodiment 18(EX18):

EFL = 8.82(mm); ΔNd = 0.054; f/# = 1.51;
TTL = 64.48(mm); FOV = 63.80(mm)

| | Radius of | | | | |
|---|---|---|---|---|---|
| | curvature | Pitch | Refractive | Abbe | |
| Surface | (mm) | (mm) | index | number | Element |
| S1 | 25.1 | 4.5 | 1.79 | 47.2 | L1(convex & concave) |
| S2 | 11.9 | 2.5 | | | |
| S3 | 6.1 | 1.5 | 1.53 | 56.3 | L2(aspherical) |
| S4 | 3.9 | 16.5 | | | (aspherical) |
| S5 | 28.2 | 3.4 | 1.80 | 34.9 | L3(double convex) |
| S6 | −101.8 | 13.4 | | | |
| S7 | Infinity | 8.6 | | | Aperture stop 14 |
| S8 | 207.0 | 3.9 | 1.50 | 81.5 | L4(double convex) |
| S9 | −11.7 | 0.7 | 1.82 | 25.2 | L5(convex & concave) |
| S10 | −34.0 | 0.2 | | | |
| S11* | Infinity | 1.4 | | | L6(uneven) |
| S12* | Infinity | 0.3 | | | |
| S13 | 53.6 | 3.6 | 1.50 | 81.5 | L7(double convex) |
| S14 | −21.7 | 0.2 | | | |
| S15 | 27.4 | 3.8 | 1.67 | 55.8 | L8(concave & convex) |
| S16 | 194.4 | 2.0 | | | |
| S17 | Infinity | 2.0 | 1.51 | 56.5 | Optical path adjt. |
| | | | | | mechanism 16 |
| S18 | Infinity | 1.0 | | | |
| S19 | Infinity | 14.0 | 1.72 | 38.0 | Prism 18 |
| S20 | Infinity | 0.5 | | | |
| S21 | Infinity | 1.1 | 1.51 | 62.9 | Protective lens 10 |
| S22 | Infinity | 0.3 | | | |

Table 2 of embodiment 18(EX18):

| Uneven Lens (gradient | C-line | d-line | F-line |
|---|---|---|---|
| refractive index) | 656.27 nm | 587.56 nm | 486.13 nm |
| n₀₀ | 1.6092 | 1.6151 | 1.6262 |
| C₁₀ | −1.461E−03 | −1.491E−03 | −1.540E−03 |
| C₂₀ | 9.986E−06 | 1.019E−05 | 1.052E−05 |

Table 3 of embodiment 18(EX18):

| Surface | K | A\hat{ }4 | B\hat{ }6 | C\hat{ }8 | D\hat{ }10 | E\hat{ }12 |
|---|---|---|---|---|---|---|
| S3 | −1.683 | −7.5105E−04 | 1.3456E−05 | −1.2816E−07 | 6.8320E−10 | −1.4753E−12 |
| S4 | −0.914 | −1.6921E−03 | 2.5908E−05 | −3.1077E−07 | 2.1017E−09 | −6.3850E−12 |

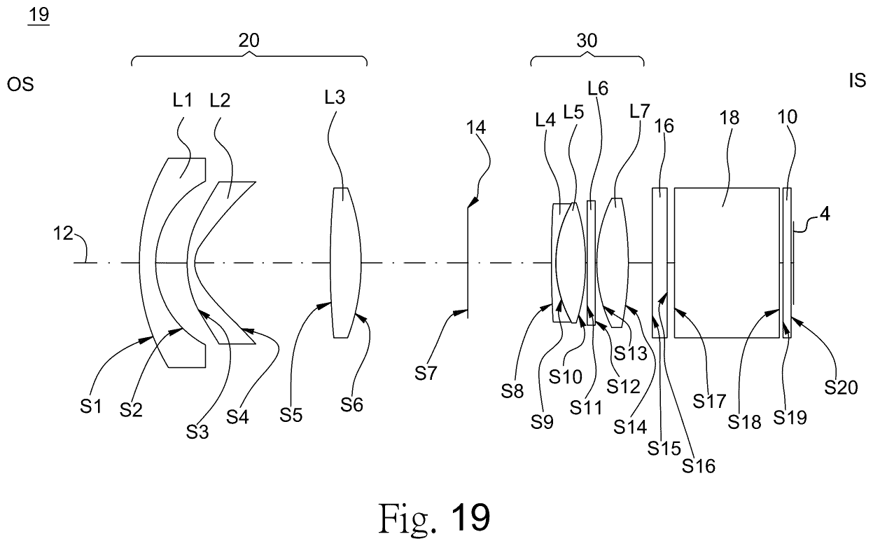

Please refer to FIG. 19, which is a schematic diagram of a lens according to Embodiment 19 (EX19) of the present invention. In this embodiment, the refractive powers of the first lens L1 to the seventh lens L7 are respectively negative, negative, positive, negative, positive, positive and positive, the second lens L2 is an aspherical lens, and the sixth lens L6 is an uneven lens with a gradient refractive index, which is a flat lens. The logic for arranging the reference numerals to the elements is the same as those in the aforementioned embodiment, and thus no need to repeat.

Table 1 of embodiment 19(EX19):

EFL = 8.81(mm); ΔNd = 0.012; f/# = 1.60;
TTL = 65.44(mm); FOV = 63.87(mm)

| | Radius of | | | | |
|---|---|---|---|---|---|
| | curvature | Pitch | Refractive | Abbe | |
| Surface | (mm) | (mm) | index | number | Element |
| S1 | 27.1 | 2.2 | 1.66 | 57.0 | L1(convex & concave) |
| S2 | 12.3 | 3.8 | | | |
| S3 | 6.1 | 1.4 | 1.53 | 56.3 | L2(aspherical) |
| S4 | 4.0 | 18.1 | | | (aspherical) |
| S5 | 105.8 | 4.1 | 1.80 | 43.8 | L3(double convex) |
| S6 | −28.6 | 14.3 | | | |
| S7 | Infinity | 11.2 | | | Aperture stop 14 |
| S8 | 134.0 | 0.6 | 1.76 | 26.6 | L4(convex & concave) |
| S9 | 16.1 | 4.0 | 1.50 | 81.5 | L5(double convex) |
| S10 | −26.3 | 0.2 | | | |
| S11* | Infinity | 1.1 | | | L6(uneven) |
| S12* | Infinity | 0.2 | | | |
| S13 | 20.0 | 4.2 | 1.56 | 70.9 | L7(double convex) |
| S14 | −40.8 | 3.2 | | | |
| S15 | Infinity | 2.0 | 1.51 | 56.5 | Optical path adjt. |
| | | | | | mechanism 16 |
| S16 | Infinity | 1.0 | | | |
| S17 | Infinity | 14.0 | 1.72 | 38.0 | Prism 18 |
| S18 | Infinity | 0.5 | | | |
| S19 | Infinity | 1.1 | 1.51 | 62.9 | Protective lens 10 |
| S20 | Infinity | 0.3 | | | |

Table 2 of embodiment 19(EX19):

| Uneven Lens (gradient | C-line | d-line | F-line |
|---|---|---|---|
| refractive index) | 656.27 nm | 587.56 nm | 486.13 nm |
| n₀₀ | 1.6009 | 1.6066 | 1.6174 |
| C₁₀ | −6.928E−04 | −7.068E−04 | −7.302E−04 |
| C₂₀ | 9.893E−06 | 1.009E−05 | 1.043E−05 |

Table 3 of embodiment 19(EX19):

| Surface | K | A\hat{ }4 | B\hat{ }6 | C\hat{ }8 | D\hat{ }10 | E\hat{ }12 |
|---|---|---|---|---|---|---|
| S3 | −1.726 | −6.0523E−04 | 9.6994E−06 | −9.3964E−08 | 4.9906E−10 | −1.0827E−12 |
| S4 | −0.909 | −1.4183E−03 | 1.8396E−05 | −2.1799E−07 | 1.3956E−09 | −3.9245E−12 |

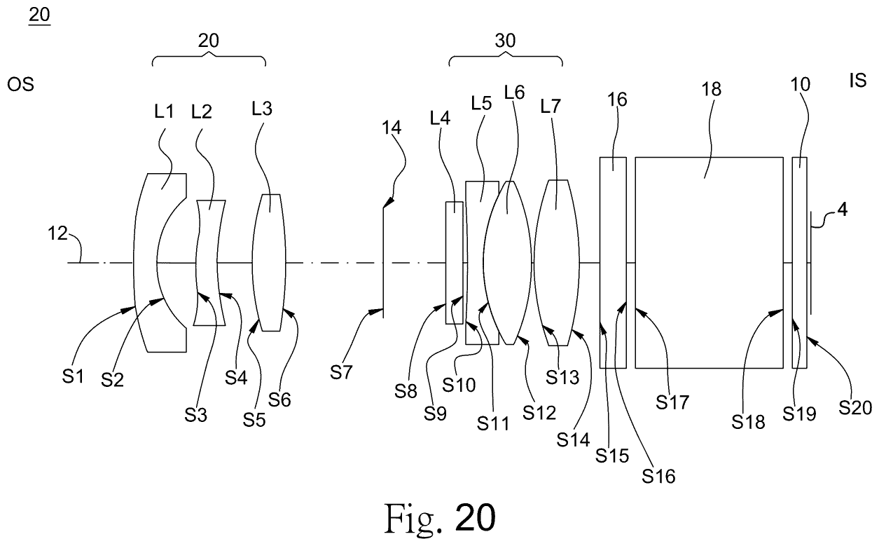

Please refer to FIG. 20, which is a schematic diagram of a lens according to Embodiment 20 (EX20) of the present invention. With a barrel (not shown), the lens 20 has an image magnification side OS and an image reduction side IS. From the image magnification side OS to the image reduction side IS, the lens 10 includes the first lens L1, the second lens L2, the third lens L3, the aperture stop 14, the fourth lens L4, the fifth lens L5, the sixth lens L6 and the seventh lens L7. The side of aperture stop 14 facing the image magnification side OS (object side) is referred to as the front of the aperture stop, also referred to as the forward or front side, and the side of aperture stop 14 facing the image reduction side IS (image side) is referred to as the rear of the aperture stop, also referred to as the backward or rear side. Behind the seventh lens L6, there are disposed in sequence: the prism 18, the protective cover 10 and the light valve 4. The first to the third lenses L1-L3 form a first lens group (also referred as the front group) 20 with negative refractive power, that is, the lens group in front of the aperture stop 14. The fourth to the seventh lenses L4-L7 constitute the second lens group (also referred as the rear group) 30 with positive refractive power, that is, the rear lens group.

In this embodiment, the refractive powers of the first lens L1 to the seventh lens L7 are respectively negative, negative, positive, negative, negative, positive, and positive, the first and second lenses L1, L2 are aspherical lenses, and the fourth lens L4 is an uneven lens with a gradient refractive index, which is a flat lens and also a cemented lens, i.e., commented with the fifth lens L5. The material of the lens closest to the image magnification side OS may be made of glass.

The difference between the embodiment 20 and the above-mentioned embodiments is that the change direction of the uneven material of the gradient index lens L4 in the embodiment 20 is not only along the radial direction, but also along the axial direction, and the formula for calculating the refractive index is as follows: n(r,z)=n₀₀+C₁₀r₂+C₂₀r⁴+C₃₀r⁶+C₄₀r⁸+C₀₁rz+C₀₁rz²+C₀₃rz³+C₀₄z⁴, where n is the refractive index, r is the radius, r²=x²+y² according to the Cartesian coordinate system with the center of the lens as the origin, the x and y denotes the coordinates of any point on the lens and the r the distance from the point to the origin (that is, the center of the lens), z is the axial distance, n(r, z) denotes the refractive index of the uneven lens, n00 is the basic refractive index, and Ci0 (C10, C20, C30, C40 . . . ) and C0j (C01, C02, C03, C04 . . . ) denote some relevant coefficients.

Table 1 of embodiment 20(EX20):

EFL = 6.25(mm); ΔNd = 0.055; f/# = 1.70;
TTL = 33.67(mm); FOV = 64.01(mm)

| | Radius of | | | | |
|---|---|---|---|---|---|
| | curvature | Pitch | Refractive | Abbe | |
| Surface | (mm) | (mm) | index | number | Element |
| S1 | −51.9 | 1.6 | 1.53 | 56.3 | L1(aspherical) |
| S2 | 6.8 | 3.2 | | | (aspherical) |
| S3 | 11.7 | 1.2 | 1.53 | 56.3 | L2(aspherical) |
| S4 | 6.5 | 2.8 | | | (aspherical) |
| S5 | 17.7 | 2.5 | 1.82 | 34.7 | L3(double convex) |
| S6 | −29.9 | 7.4 | | | |
| S7 | Infinity | 4.7 | | | Aperture stop 14 |
| S8* | Infinity | 1.3 | | | L4(uneven) |
| S9* | Infinity | 0.3 | | | |
| S10 | −82.3 | 1.2 | 1.85 | 23.8 | L5(double concave) |
| S11 | 12.0 | 3.7 | 1.62 | 63.3 | L6(double convex) |
| S12 | −14.9 | 0.2 | | | |
| S13 | 18.2 | 3.4 | 1.73 | 51.4 | L7(double convex) |
| S14 | −22.7 | 1.6 | | | |
| S15 | Infinity | 2.0 | 1.51 | 56.5 | Optical path adjt. |
| | | | | | mechanism 16 |
| S16 | Infinity | 0.7 | | | |
| S17 | Infinity | 11.2 | 1.72 | 38.0 | Prism 18 |
| S18 | Infinity | 0.7 | | | |
| S19 | Infinity | 1.1 | 1.51 | 62.9 | Protective lens 10 |
| S20 | Infinity | 0.3 | | | |

Table 2 of embodiment 20(EX20):

| Uneven Lens (gradient | C-line | d-line | F-line |
|---|---|---|---|
| refractive index) | 656.27 nm | 587.56 nm | 486.13 nm |
| n₀₀ | 1.4888 | 1.4935 | 1.5054 |
| C₁₀ | 9.484E−04 | 9.579E−04 | 9.514E−04 |
| C₂₀ | 7.294E−05 | 7.366E−05 | 7.317E−05 |
| C₃₀ | 0 | 0 | 0 |
| C₄₀ | 0 | 0 | 0 |
| C₀₁ | 0 | 0 | 0 |
| C₀₂ | −6.383E−04 | −6.446E−04 | −6.403E−04 |

Table 3 of embodiment 20(EX20):

| Surface | K | A\hat{ }4 | B\hat{ }6 | C\hat{ }8 | D\hat{ }10 |
|---|---|---|---|---|---|
| S1 | 0 | 9.1099E−04 | −5.6717E−06 | −6.5778E−08 | 1.5043E−09 |
| S2 | 0 | −5.7731E−04 | 6.0829E−05 | −1.2373E−06 | 0.0000E+00 |
| S3 | 0.642 | −6.7225E−03 | 3.1772E−04 | −9.2310E−06 | 1.0946E−07 |
| S4 | −8.650 | −2.5884E−03 | 1.7066E−04 | −5.3308E−06 | 7.2492E−08 |

In summary, the present invention can achieve the purpose of reducing the size of the lens through the design of each embodiment. The projection lens provided by the present invention uses uneven materials to manufacture achromatic lenses, thereby replacing cemented lenses whose volume is larger (usually thicker), that is, the volume of the lens or lens group with achromatic function can be reduced through the use of uneven materials. Furthermore, since a single piece of gradient index lens can replace a cemented lens, if the gradient index lens of the present invention is cemented with another lens, as shown in FIG. 7, the effect of two cemented lenses can be achieved while the size is still small, and the purpose of reducing the volume of the lens is still achieved on the whole. Therefore, the present invention employing uneven material lens has great contribution to related industries.

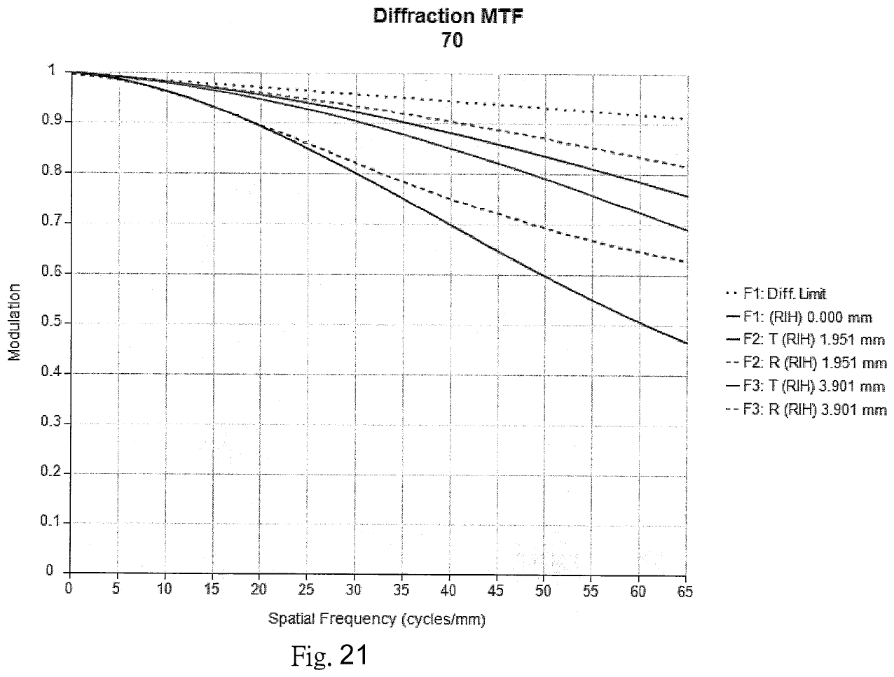

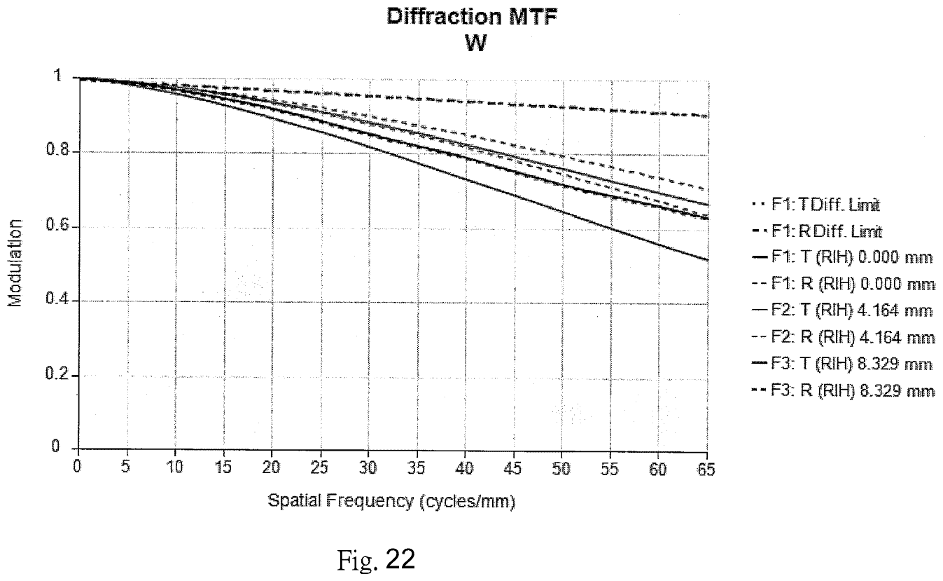

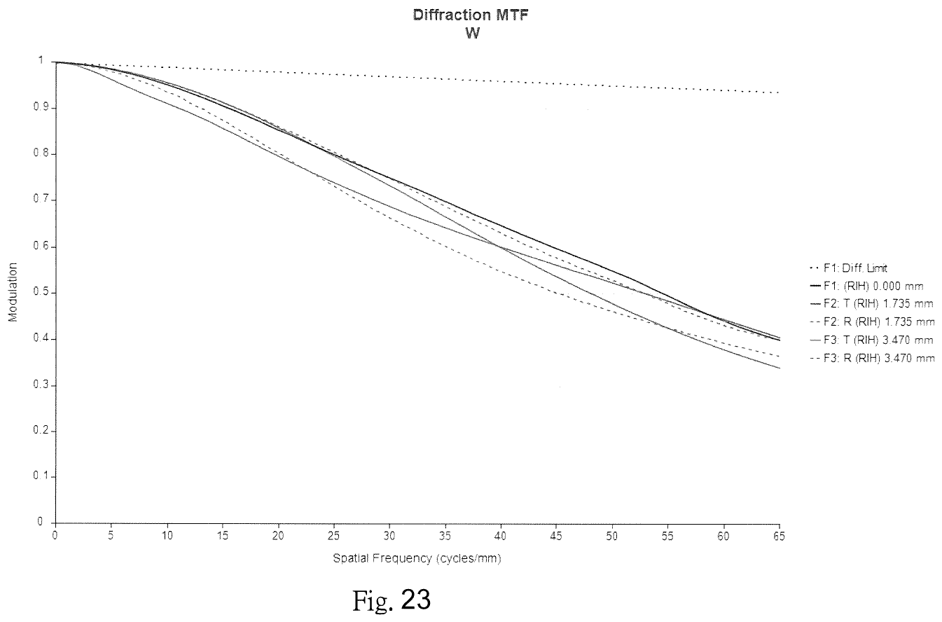

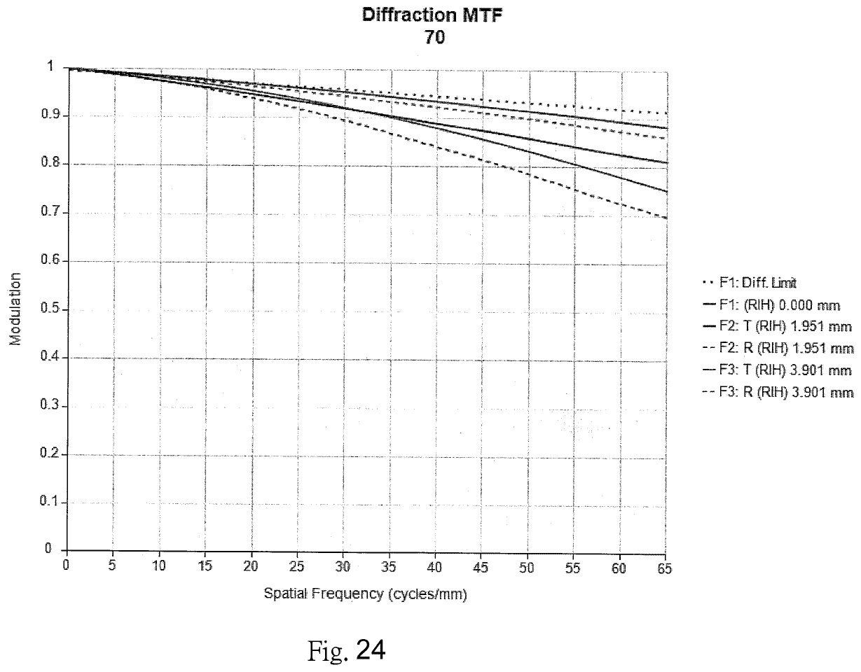

FIGS. 21 to 24 are the simulated data graphs of the optical transfer function (MTF) of the embodiments EX1, EX9, EX10, EX20 of the present invention respectively. The illustrations shown in the simulated data graphs in FIGS. 21 to 24 are all within the standard range, thus it can be verified that the projection lenses of the various embodiments of the present invention can indeed have good quality in terms of optical imaging characteristics.

While the invention has been described in terms of what is presently considered to be the most practical and preferred Embodiments, it is to be understood that the invention need not be limited to the disclosed Embodiments. On the contrary, it is intended to cover various modifications and similar arrangements included within the spirit and scope of the appended claims, which are to be accorded with the broadest interpretation so as to encompass all such modifications and similar structures.

What is claimed is:

1. A projection lens, comprising:
a first lens with refractive power, a second lens with refractive power, a third lens with refractive power, a fourth lens with refractive power and a fifth lens with refractive power arranged in order from an magnification side to a reduction side of the projection lens; and
an aperture stop disposed between the second lens and the reduction side, wherein a sum of the refractive powers of the lenses with refractive powers disposed between the aperture stop and the reduction side is positive, and a number of the of lenses with refractive powers of the projection lens is less than 12, wherein:
at least one of the second lens, the third lens, the fourth lens and the fifth lens is a gradient index lens, which satisfies the condition of 0.6>T/D>0.035, where T is a thickness of the gradient index lens at a center of the gradient index lens, and D is a maximum outer diameter of the gradient index lens.

2. The projection lens according to claim 1, wherein the lenses disposed between the magnification side and the aperture stop form a first lens group, the first lens group includes at least one aspherical lens.

3. The projection lens according to claim 1, wherein an f-number of the aperture stop is between 1.35 and 2.5.

4. The projection lens according to claim 1, wherein a gradient direction of a refractive index of the gradient index lens is an axial direction thereof.

5. The projection lens according to claim 1, wherein the gradient index lens satisfies the following conditions: ΔNd≤Ndₘₐₓ−Ndₘᵢₙ<0.24, wherein Ndₘₐₓ is a maximum Nd value of the gradient index lens, Ndₘᵢₙ is a minimum Nd value of the gradient index lens, and the Nd value is a refractive index of the gradient index lens at helium d-line.

6. The projection lens according to claim 1, wherein a gradient direction of a refractive index of the gradient index lens is a radial direction thereof.

7. A projection lens, comprising:
a first lens with refractive power, a second lens with refractive power, a third lens with refractive power, a fourth lens with refractive power and a fifth lens with refractive power arranged in order from an magnification side to a reduction side of the projection lens; and
an aperture stop disposed between the second lens and the reduction side, wherein a sum of the refractive powers of the lenses with refractive powers disposed between the aperture stop and the reduction side is positive, and a number of the of lenses of the projection lens is less than 12, wherein:
at least one of the second lens, the third lens, the fourth lens and the fifth lens is a uneven material lens, which satisfies the condition of 0.6>T/D>0.035, where T is a thickness of the uneven material lens on the optical axis of the projection lens, and D is a maximum outer diameter of the uneven material lens.

8. The projection lens according to claim 7, wherein the lenses disposed between the magnification side and the aperture stop form a first lens group, the first lens group includes at least one aspherical lens.

9. The projection lens according to claim 7, wherein an f-number of the aperture stop is between 1.35 and 2.5.

10. The projection lens according to claim 7, wherein a gradient direction of a refractive index of the heterogeneous lens is an axial direction thereof.

11. The projection lens according to claim 7, wherein the uneven material lens is a gradient index lens.

12. The projection lens according to claim 11, wherein the gradient index lens satisfies the following conditions: ΔNd≤Ndₘₐₓ−Ndₘᵢₙ<0.24, wherein Ndₘₐₓ is a maximum Nd value of the gradient index lens, Ndₘᵢₙ is a minimum Nd value of the gradient index lens, and the Nd value is a refractive index of the gradient index lens at helium d-line.

13. The projection lens according to claim 11, wherein a gradient direction of a refractive index of the gradient index lens is a radial direction thereof.

14. The projection lens according to claim 7, wherein at least one side of the uneven lens has a curved surface.

15. The projection lens according to claim 14, wherein the curved surface is spherical surface or aspherical surface, or has a diffraction structure thereon.

16. A projection lens, comprising:
a first lens with refractive power, a second lens with refractive power, a third lens with refractive power, a fourth lens with refractive power and a fifth lens with refractive power arranged in order from an magnification side to a reduction side of the projection lens; and
an aperture stop disposed between the second lens and the reduction side, wherein a sum of the refractive powers of the lenses with refractive powers disposed between the aperture stop and the reduction side is positive, and a number of the of lenses of the projection lens is less than 12, wherein:
at least one of the second lens, the third lens, the fourth lens and the fifth lens is a flat plate with a smooth surface and no microstructure, which satisfies the condition of 0.6>T/D>0.035, where T is a thickness of the flat plate on the optical axis of the projection lens, and D is a maximum outer diameter of the flat plate.

17. The projection lens according to claim 16, wherein the flat lens is a gradient index lens.

18. The projection lens according to claim 17, wherein the gradient index lens satisfies the following conditions: ΔNd≤Ndₘₐₓ−Ndₘᵢₙ<0.24, wherein Ndₘₐₓ is a maximum Nd value of the gradient index lens, Ndₘᵢₙ is a minimum Nd value of the gradient index lens, and the Nd value is a refractive index of the gradient index lens at helium d-line.

19. The projection lens according to claim 17, wherein a gradient direction of a refractive index of the gradient index lens is a radial direction thereof.

20. The projection lens according to claim 19, wherein a surface of the gradient index lens has an inflection point.

21. The projection lens according to claim 20, wherein the surface of the gradient index lens is an aspherical surface.

22. The projection lens according to claim 19, the gradient index lens is a cemented lens.

23. The projection lens according to claim 16, wherein the lenses disposed between the magnification side and the aperture stop form a first lens group, the first lens group includes at least one aspherical lens.

24. The projection lens according to claim 16, wherein an f-number of the aperture stop is between 1.35 and 2.5.

25. The projection lens according to claim 16, wherein a gradient direction of a refractive index of the gradient index lens is an axial direction thereof.
